(19) United States
(12) Patent Application Publication
(10) Pub. No.: US 2017/0236449 A1
(43) Pub. Date: Aug. 17, 2017

(54) EDUCATIONAL CARD GAMES AND METHODS OF PLAY

(71) Applicant: CATLILLI GAMES, WARRENTON, VA (US)

(72) Inventors: Catherine Croft SWANWICK, Warrenton, VA (US); Jonathan NARDOLILLI, Falls Church, VA (US)

(73) Assignee: CATLILLI GAMES, WARRENTON, VA (US)

(21) Appl. No.: 15/043,441

(22) Filed: Feb. 12, 2016

(51) Int. Cl. G09B 19/22; G09B 19/00

(52) U.S. Cl. CPC G09B 19/22; G09B 19/00

(57) ABSTRACT

The card-game system may include at least one deck of playing cards and one or more sets of rules for playing the educational game(s) using the deck. A deck may include multiple sets of cards. The cards in a first set may relate to a first item that is subject to a cycle, including a number of stages. Cards in a second set may relate to a second item that is subject to a cycle, including a number of stages. Different cards within a set may represent different stages of the cycle for the item of that set. For example, different cards in the first set may relate to different stages of the cycle of the first item and different cards in the second set may relate to different stages of the cycle of the second item. The methods of gameplay may include playing cards based on the sets, the cycles and sequential stages of a cycle within in set. Due in part to this game mechanic, the players get exposed to and ideally learn about the cycles of an item, and the stages and order of the stages of a cycle for that item.

### FIELD OF THE INVENTION

The invention relates to educational card games, methods of playing the games and cards with specific functional features to facilitate the educational game play, including using the same cards to play different games suitable for different groups of players.

### BACKGROUND OF THE INVENTION

Various card-based games for educational purposes exist. None of the known games use cards that have the design of the present invention, nor are there known games that provide the features of the invention, including a card game to help teach various cycles, e.g., life cycles, nature cycles, genetic engineering cycles and other cycles. Various other drawbacks and shortcomings exist with known card games.

### SUMMARY OF THE INVENTION

The invention addressing these and other drawbacks of known card-based games relates to a card-game system including a set of specially designed cards and a method of playing one or more educational games with the cards. According to one aspect of the invention, the cards are designed for uniquely engaging children (or other players) in the study of various cycles, e.g., life cycles, nature cycles, genetic engineering cycles and other cycles, for example, in Science, Technology, Engineering, and Mathematics (STEM), or other fields. The cards may also include different elements such that players of different age groups or abilities can play different games or different versions of a common game, using the same deck of cards.

According to an aspect of the invention, the card-game system may include at least one deck of playing cards and one or more sets of rules for playing the educational game(s) using the deck. A deck may include multiple sets of cards. The cards in a first set may relate to a first item that is subject to a cycle, including a number of stages. Cards in a second set may relate to a second item that is subject to a cycle, including a number of stages. Different cards within a set may represent different stages of the cycle for the item of that set. For example, different cards in the first set may relate to different stages of the cycle of the first item and different cards in the second set may relate to different stages of the cycle of the second item.

Cards within a deck may include a particular format with a number of common elements, e.g., printed indicia in a common format, which have a functional purpose with respect to the game play and educational features of the invention. According to one aspect of the invention, the elements may include an item identifier indicia, a cycle stage number indicia, a cycle stage descriptor indicia, a cycle stage depiction, a cycle descriptor indicia, a power indicator and/or other elements.

Within a set of cards, one or more indicia may be common to the cards in that set (e.g., an item identifier indicia). Other indicia of the cards in a set may differ from one or more other cards in the set, based on other indicia being different. However, the cards of a set collectively may represent sequential stages of a cycle relating to the common item in the set. The cards of the set may include indicia to reflect a stage of the cycle and the relative order of that stage to the cycle.

According to another aspect of the invention, at least two sets of rules may be associated with a common deck of cards, representing two methods of gameplay for the same deck of playing cards. The sets of rules may be distinguished by their target group factors (e.g., age, learning abilities or other factors). The different sets of rules may use different indicia printed on the cards and/or use the indicia differently from one method of play to the next.

Examples of game rules using the cards is provided below. In general, the methods of gameplay may include playing cards based on the sets, the cycles and sequential stages of a cycle within a set. Due in part to this game mechanic, the players get exposed to and ideally learn about the cycles of an item, and the stages and order of the stages of a cycle for that item.

These and other objects, features, and characteristics of the card-game system, the cards and methods of play disclosed herein, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

FIG. 1 is an exemplary illustration of the functional layout of cards used in the game system for playing educational games.

FIG. 2 is an exemplary illustration of a set of cards.

FIG. 3 is an exemplary illustration of one method of game play using the cards and the indicia printed on the card.

FIG. 4 is an exemplary illustration of another method of game play using the cards and the indicia printed on the card.

FIGS. 5-56 are exemplary illustrations of particular cards used in the game system for playing educational games.

### DETAILED DESCRIPTION OF THE INVENTION

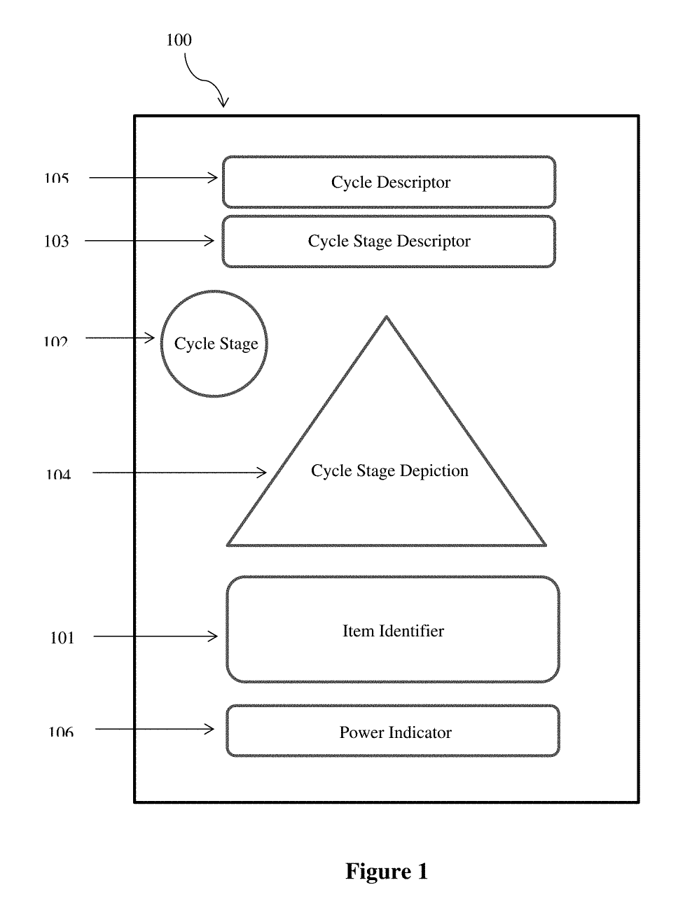

According to an aspect of the invention, the card-game system may include at least one deck of playing cards and one or more sets of rules for playing the educational game(s) using the deck. A deck may include multiple sets of cards 100. Cards 100 within a deck may include a particular format with a number of elements, e.g., printed indicia, which have a functional purpose with respect to the game play and educational features of the invention. FIG. 1 depicts an exemplary illustration of a functional layout of cards 100 used in the game system and for playing educational games. According to one aspect of the invention, the elements may include an item identifier indicia 101, a cycle stage number indicia 102, a cycle stage descriptor indicia 103, a cycle stage depiction 104, a cycle descriptor indicia 105, a power indicator 106, and/or other indicia or other elements. An item identifier indicia 101 represents a description or title of the item that is subject to a cycle, e.g., a butterfly, a cell, or any other item subject to a cycle. A cycle stage indicia 102 is a sequential identifier identifying which stage of the cycle the card is representing (e.g., 1, 2, 3 . . . or A, B, C . . . ). A cycle stage descriptor indicia 103 represents a description or title of the stage of the cycle for a given item. A cycle stage depiction 104 is a graphical representation of the stage of the cycle for a given item. A cycle descriptor indicia 105 represents a description or title of the cycle for a given item. A power indicator 106 represents a description of a game playing ability that a player may utilize according to one or more methods of playing educational games described herein.

The cards 100 in a first set may relate to a first item that is subject to a cycle. Cards in a second set may relate to a second item that is subject to a cycle. Different cards within a set may represent different stages of the cycle for the item of that set. For example, different cards in the first set may relate to different stages of the cycle of the first item and different cards in the second set may relate to different stages of the cycle of the first item.

Within a set of cards, one or more indicia may be common to the cards in that set (e.g., item identifier indicia, power indicator, cycle descriptor, background color and/or other indicia). Other indicia of the cards in a set may differ from one or more other cards in the set, based on other indicia being different. However, the cards of a set collectively may represent sequential stages of a cycle relating to the common item in the set. The cards of the set may include indicia to reflect a stage of the cycle and the relative order of that stage to the cycle. Within a set of cards, one or more indicia (e.g., power indicator) may be thematically related to the cycle to help illustrate a function or feature of the cycle. The power indicator may serve a functional purpose in connection with different methods of play as described below.

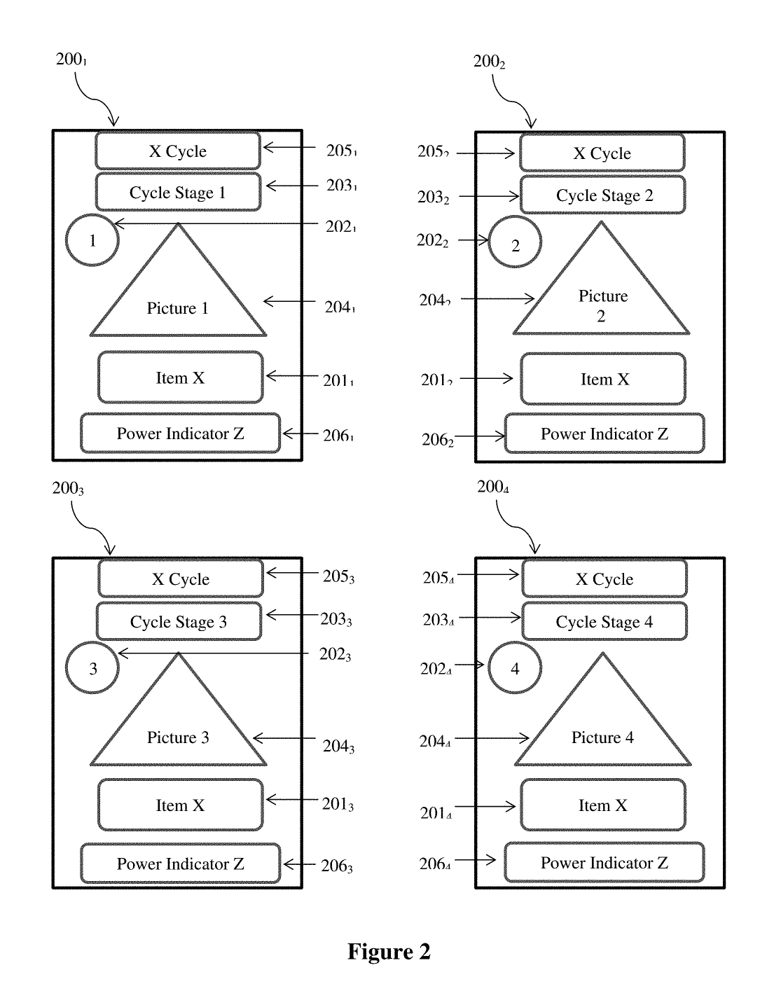

FIG. 2 depicts an example of a set of cards. As shown, the set includes cards 200₁, 200₂, 200₃ and 200₄. More or less cards can be included in the sets. As shown, the cards of this set all relate to a common item identifier 200₁₋₄ (Item X). Card 200₁ includes a cycle stage number indicator 202₁(1), a cycle stage descriptor 203₁ (Cycle Stage 1), a cycle stage depiction 204₁ (e.g., a picture representing the stage, such as picture 1) and may further include a cycle descriptor 205₁(X Cycle)and a power indicator 206₁ (Power indicator Z). Card 200₂ includes a cycle stage number indicator 202₂ (2), cycle stage descriptor 203₂ (cycle stage 2), a cycle stage depiction 204₂ (e.g., a picture representing the stage, such as picture 2) and may further include a cycle descriptor 205₂ (X Cycle)and a power indicator 206₂ (Power indicator Z). Card 200₃ includes a cycle stage number indicator 202₃ (3), cycle stage descriptor 203₃ (cycle stage 3), a cycle stage depiction 204₃ (e.g., a picture representing the stage, such as picture 3) and may further include a cycle descriptor 205₃ (X Cycle) and a power indicator 206₃ (Power indicator Z). Card 200₄ includes a cycle stage number indicator 202₄ (4), cycle stage descriptor 203₄ (cycle stage 4), a cycle stage depiction 204₄ (e.g., a picture representing the stage, such as picture 4) and may further include a cycle descriptor 205₄ (X Cycle) and a power indicator 206₄ (Power indicator Z).

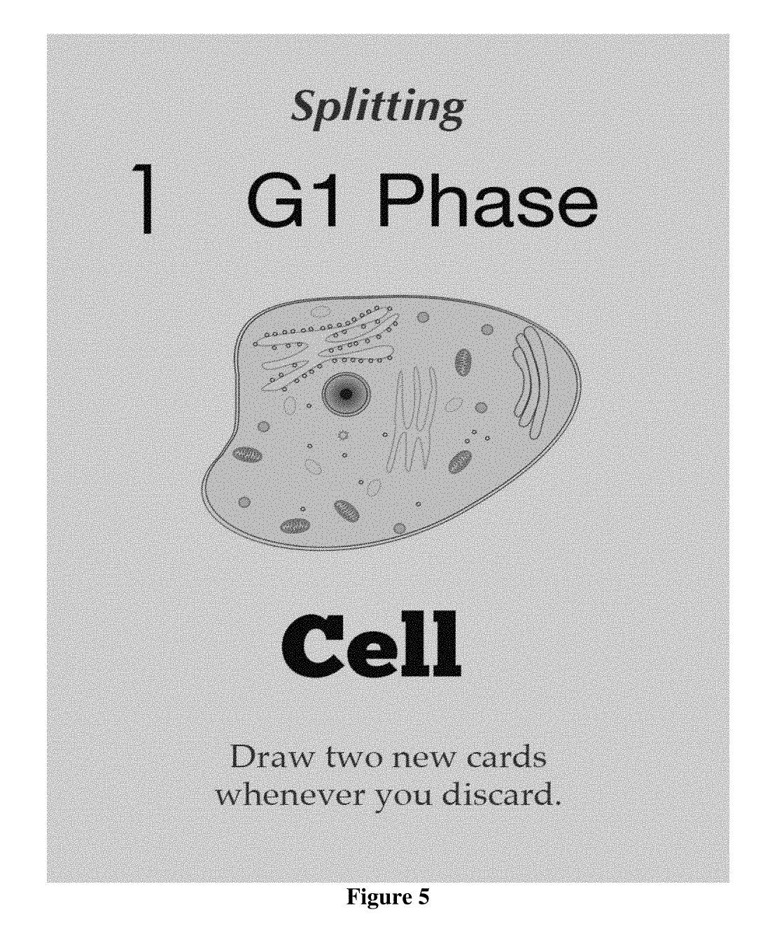

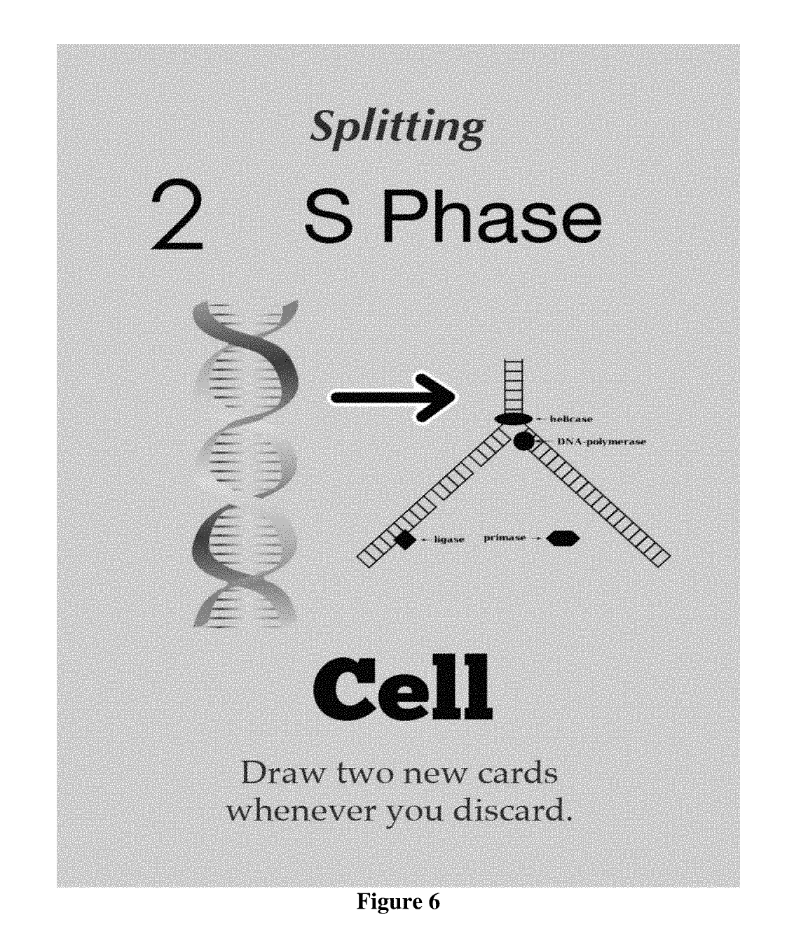

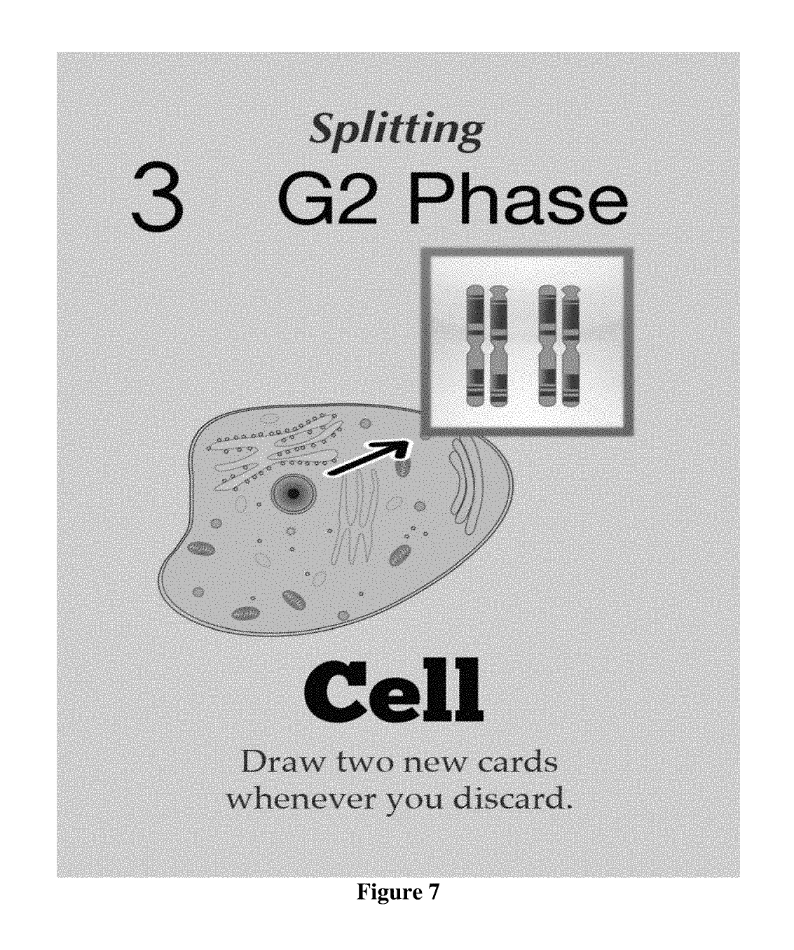

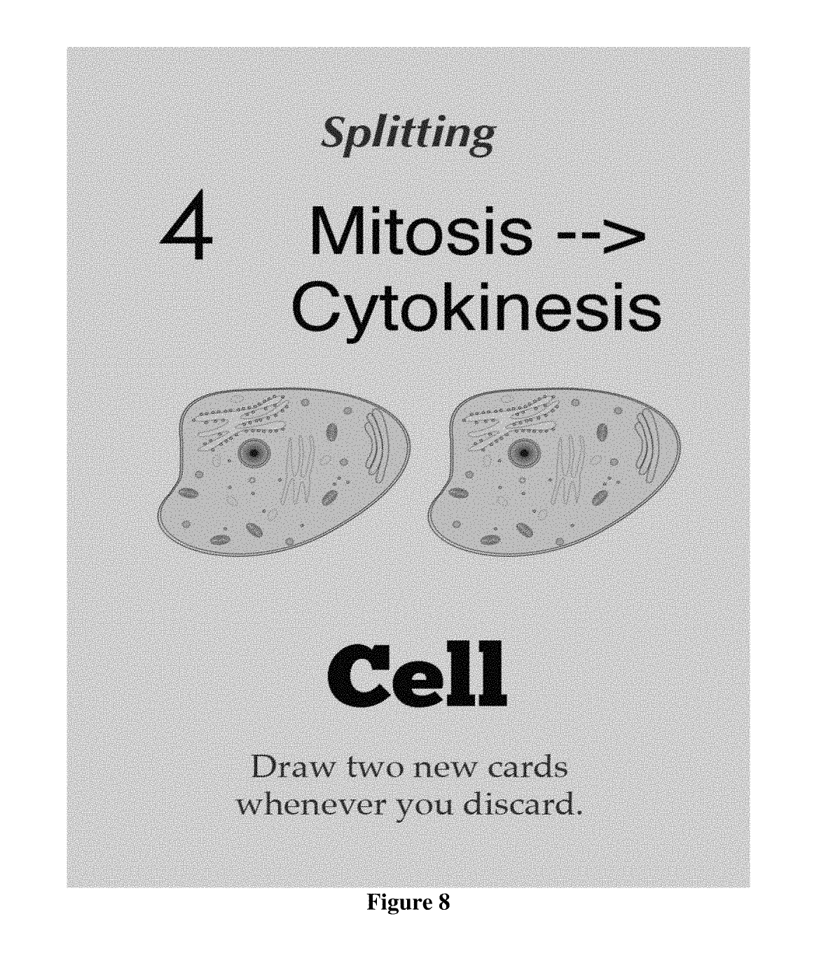

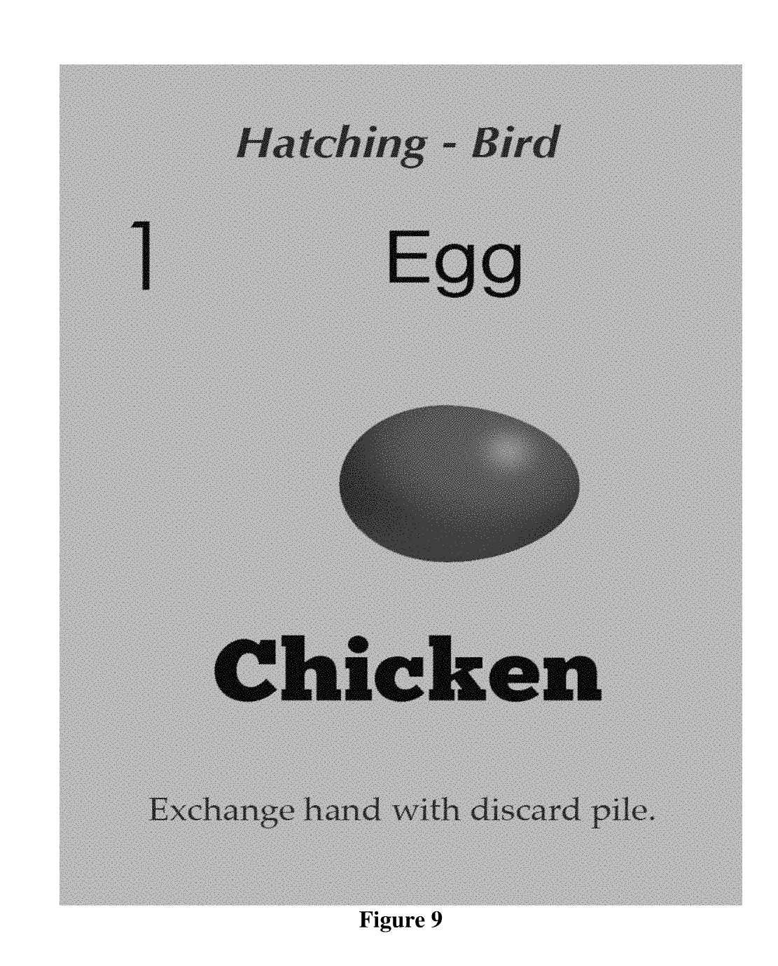

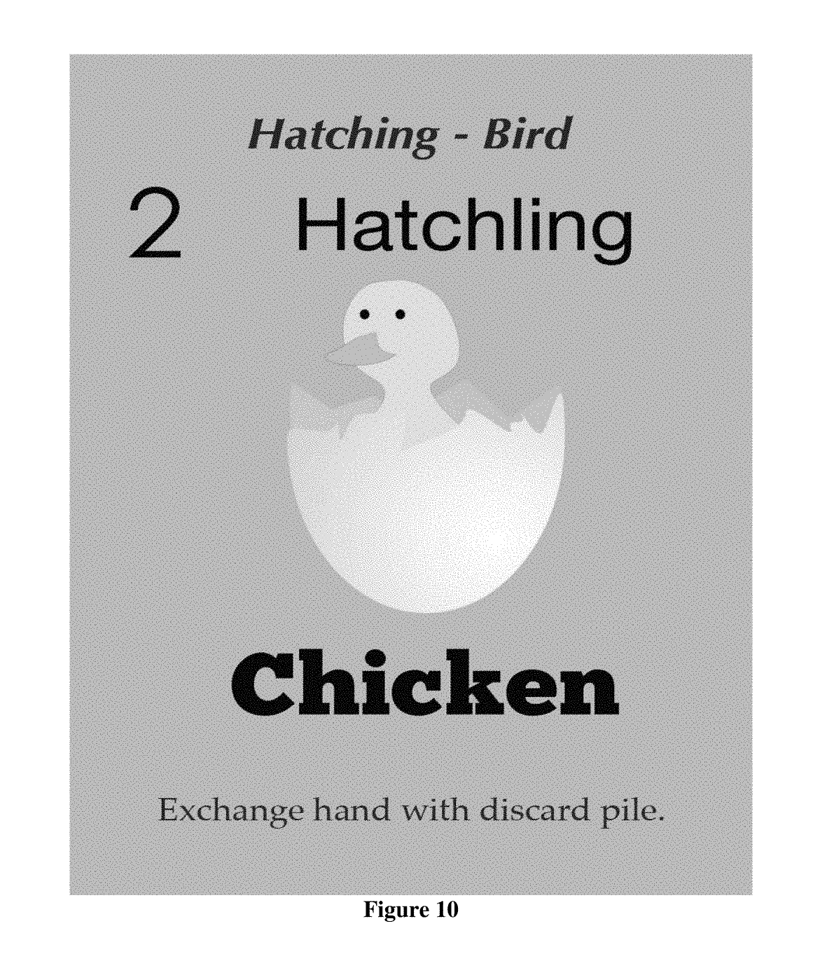

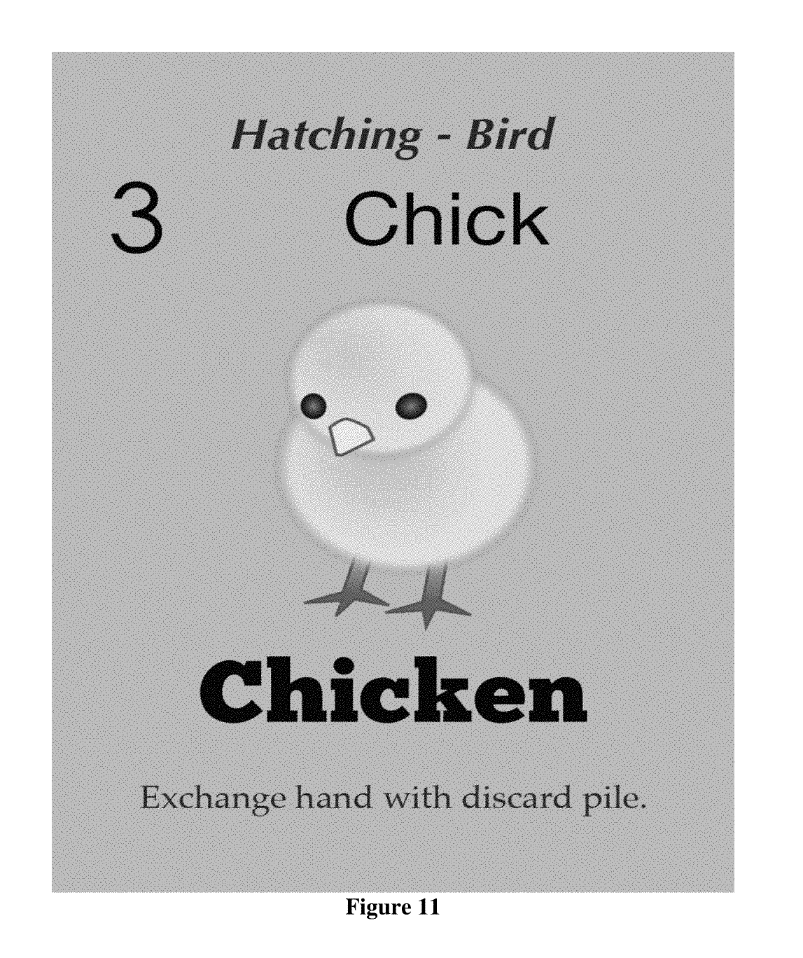

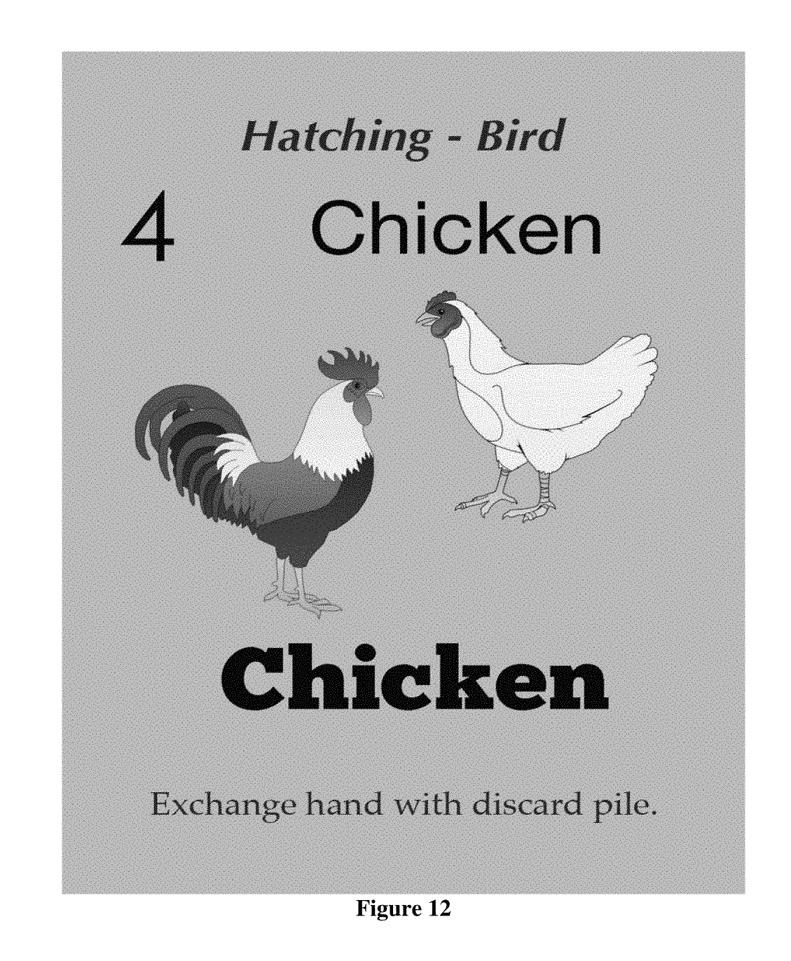

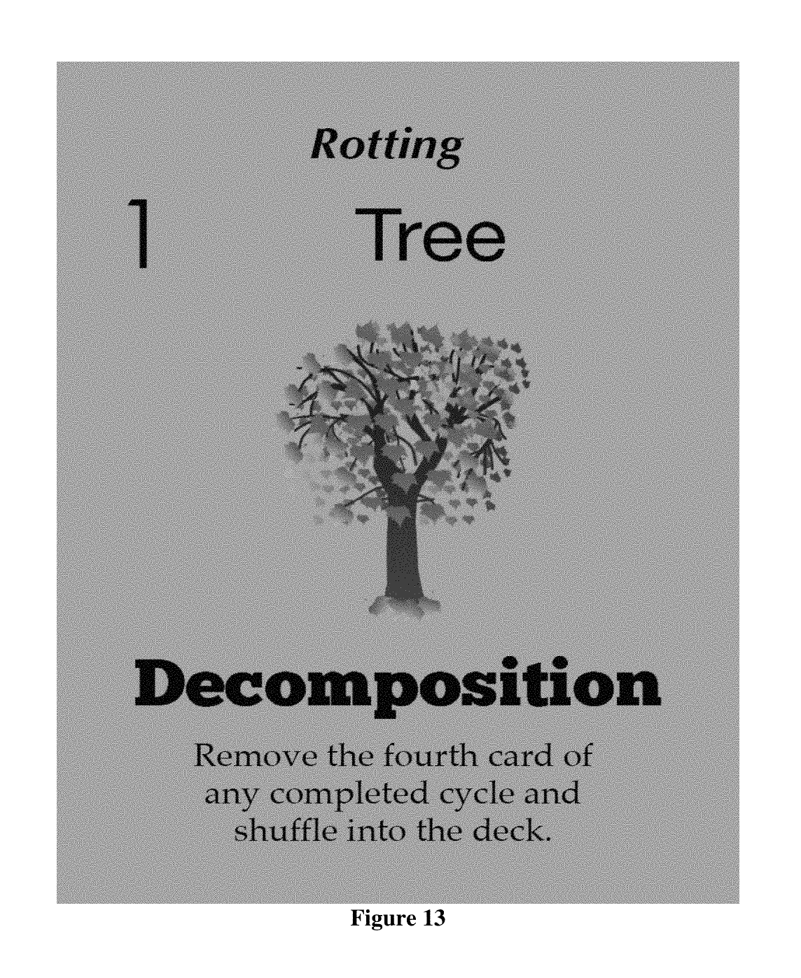

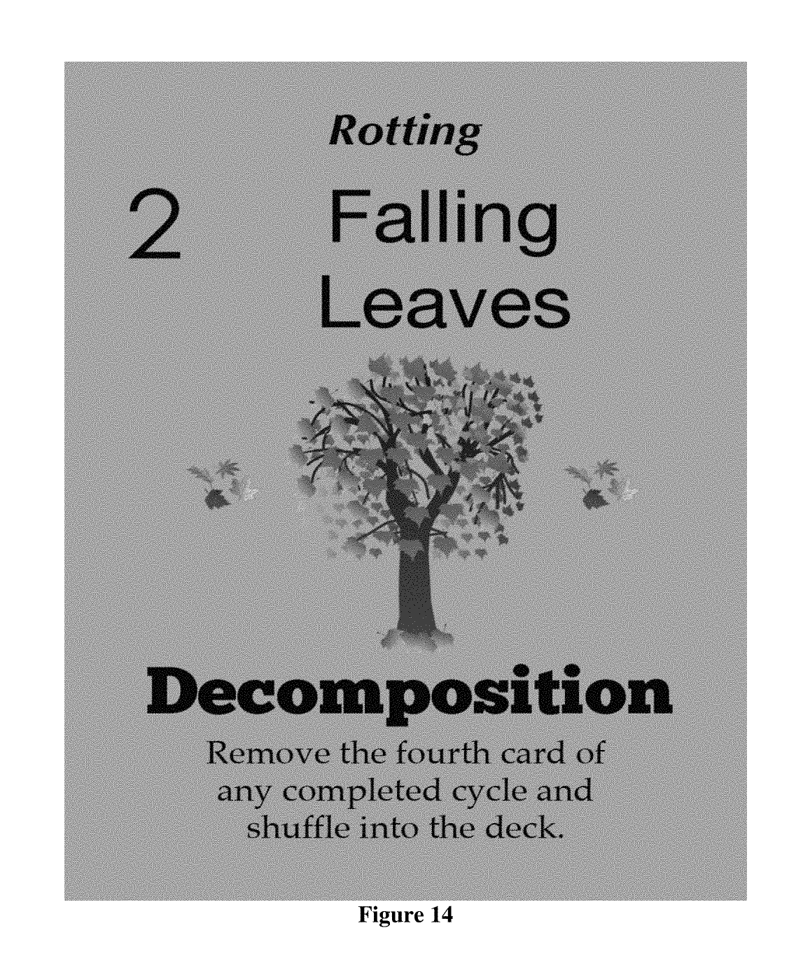

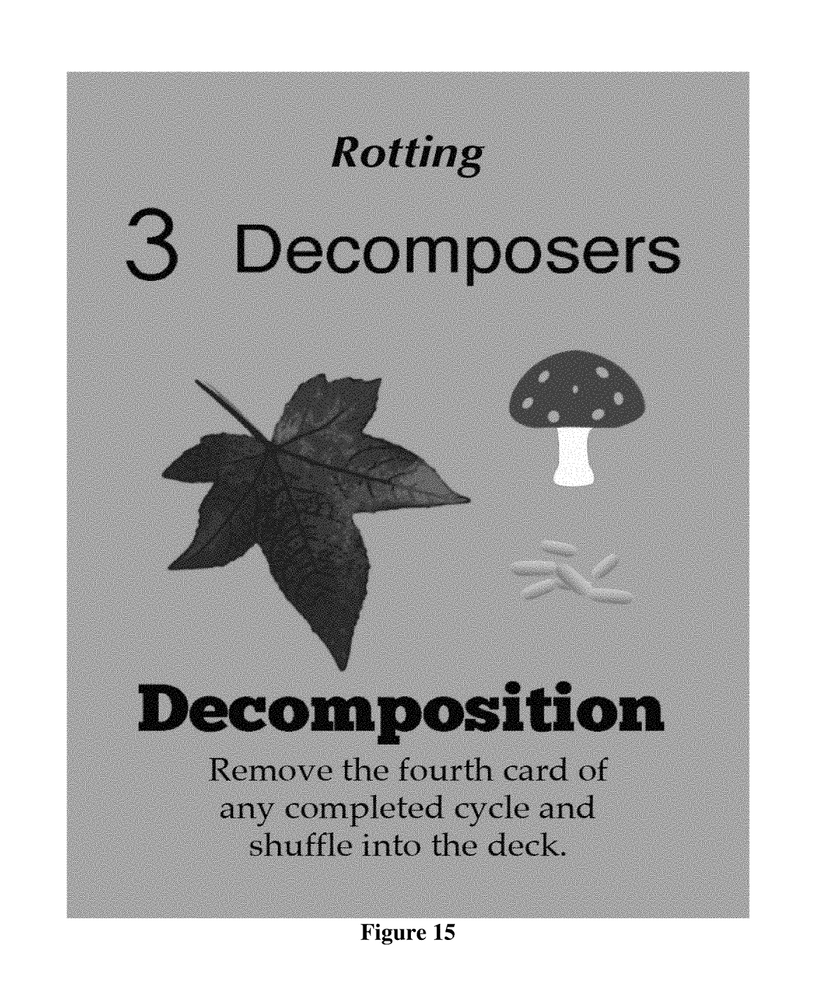

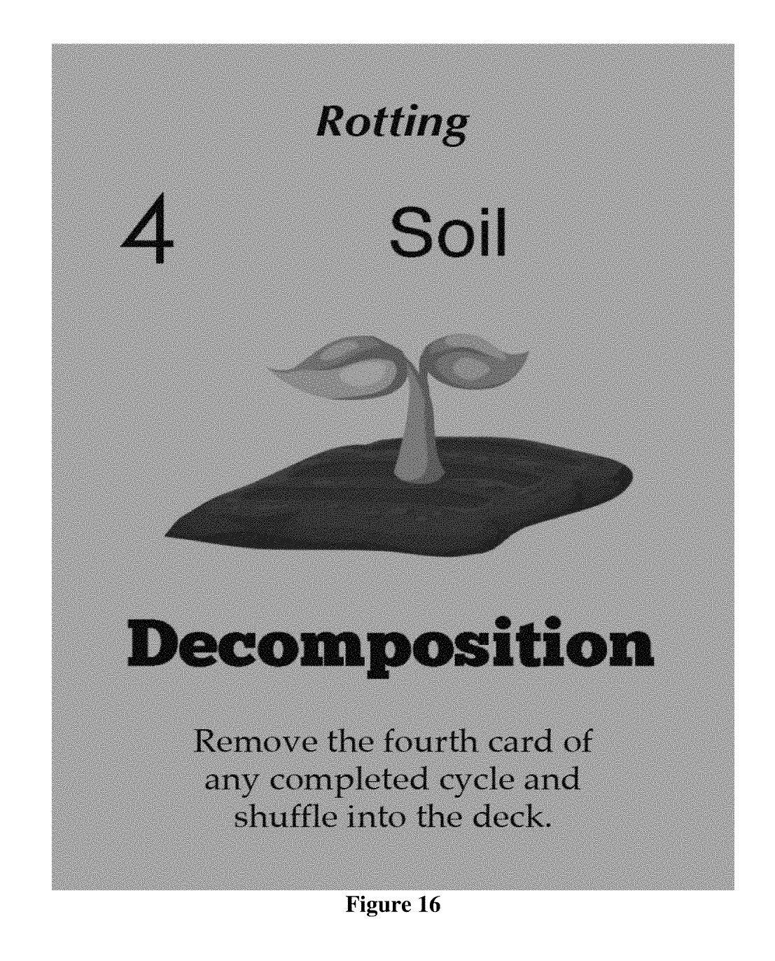

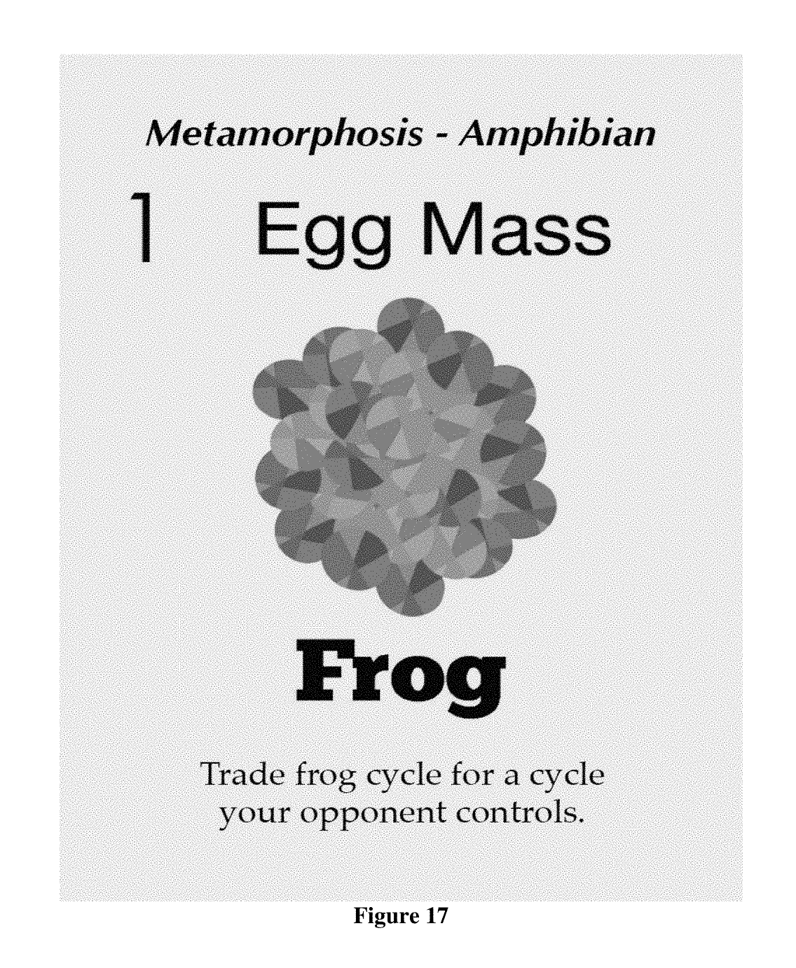

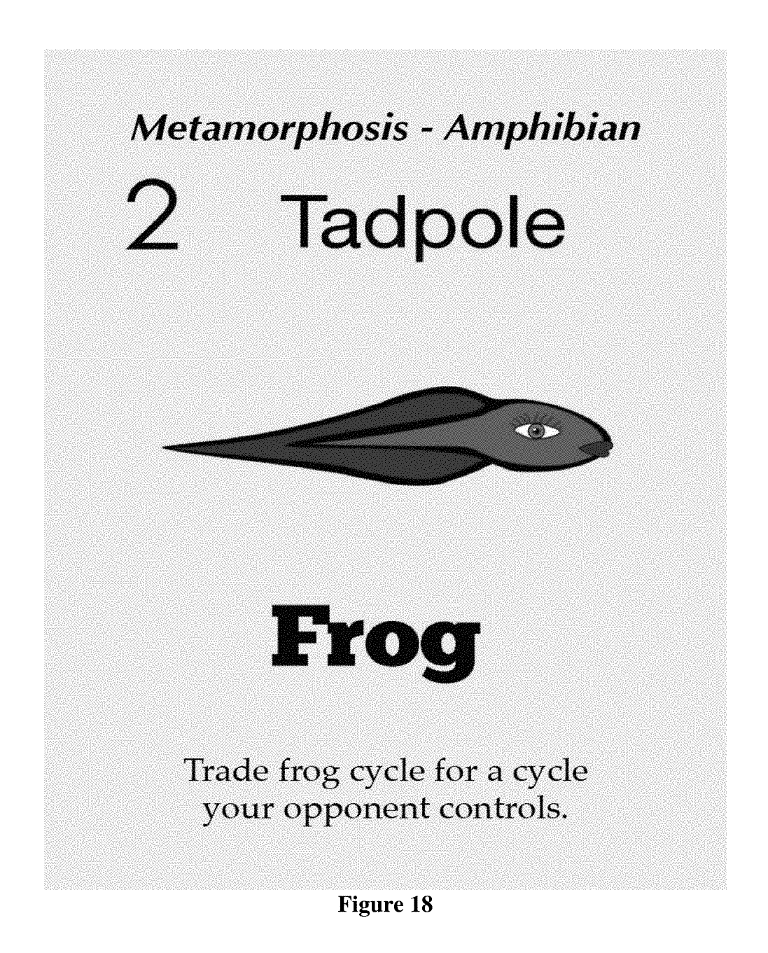

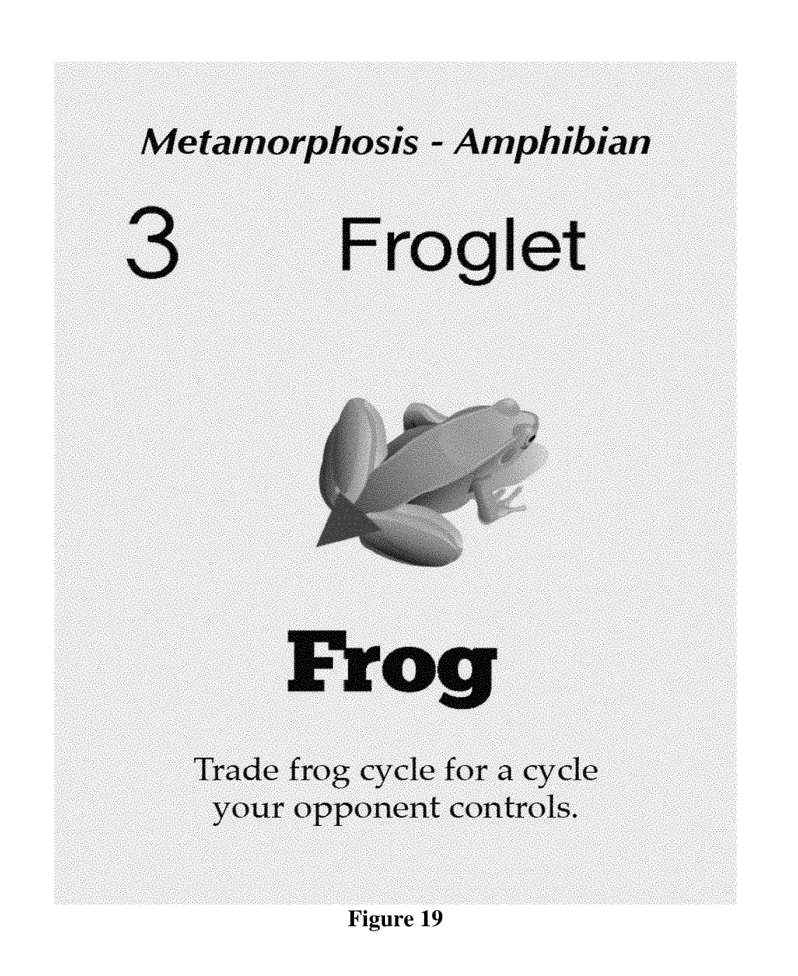

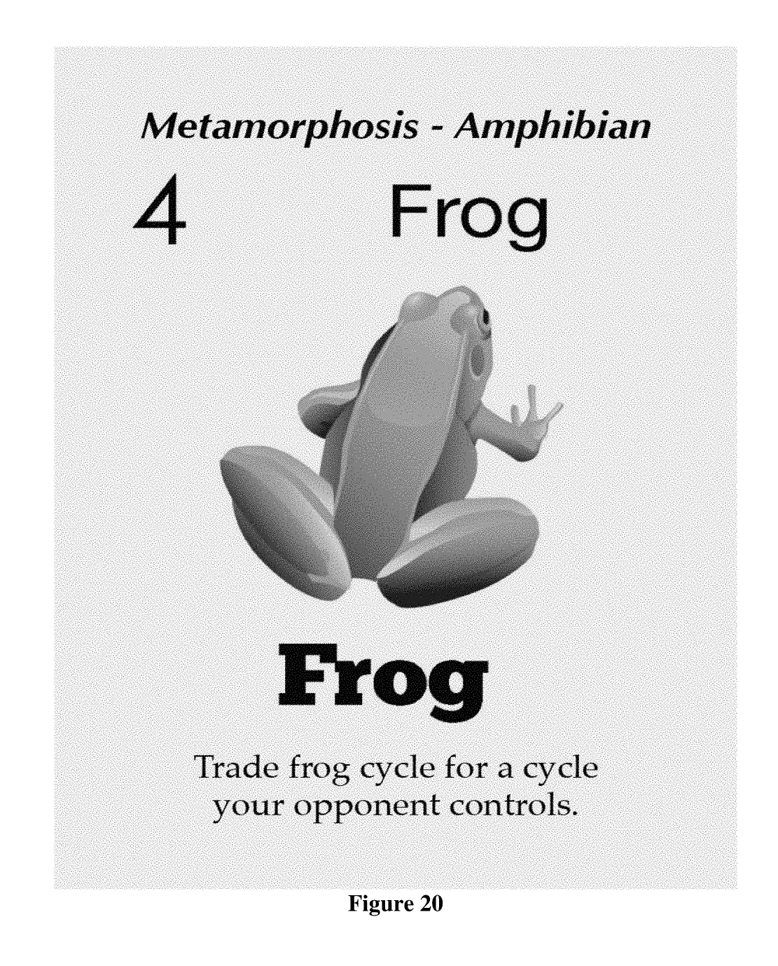

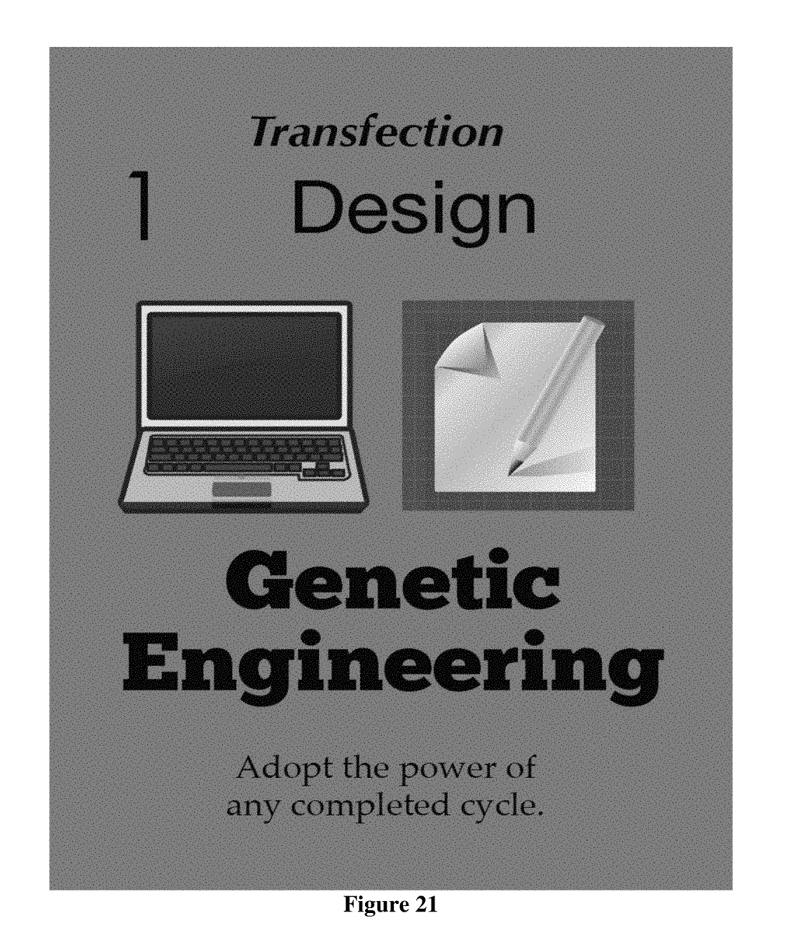

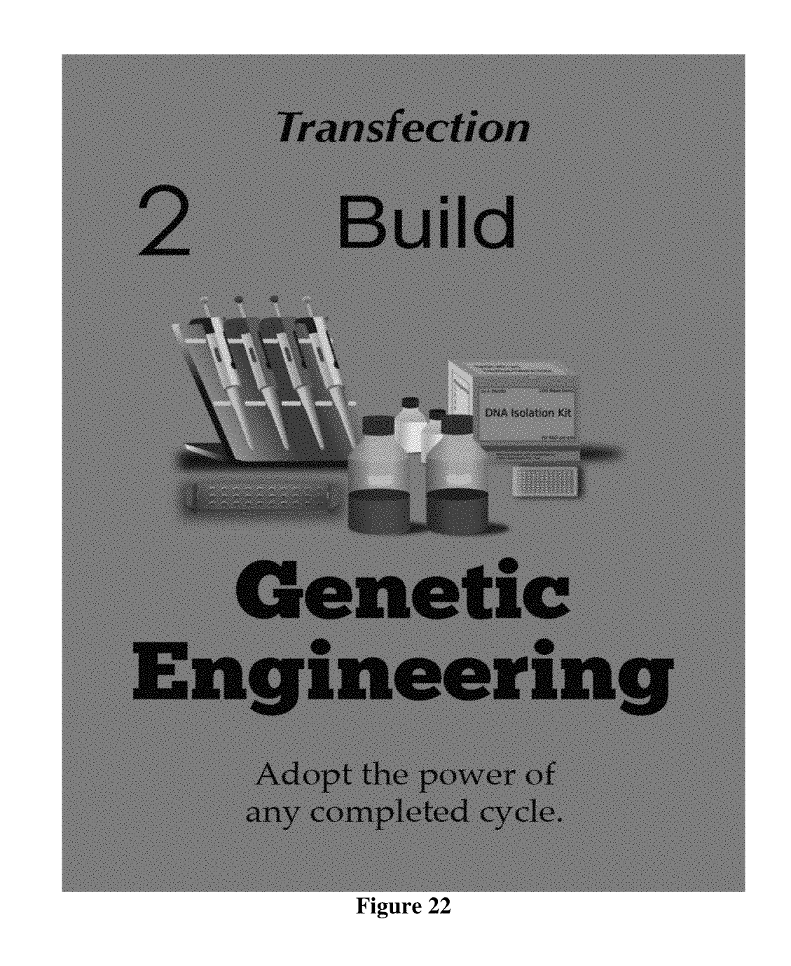

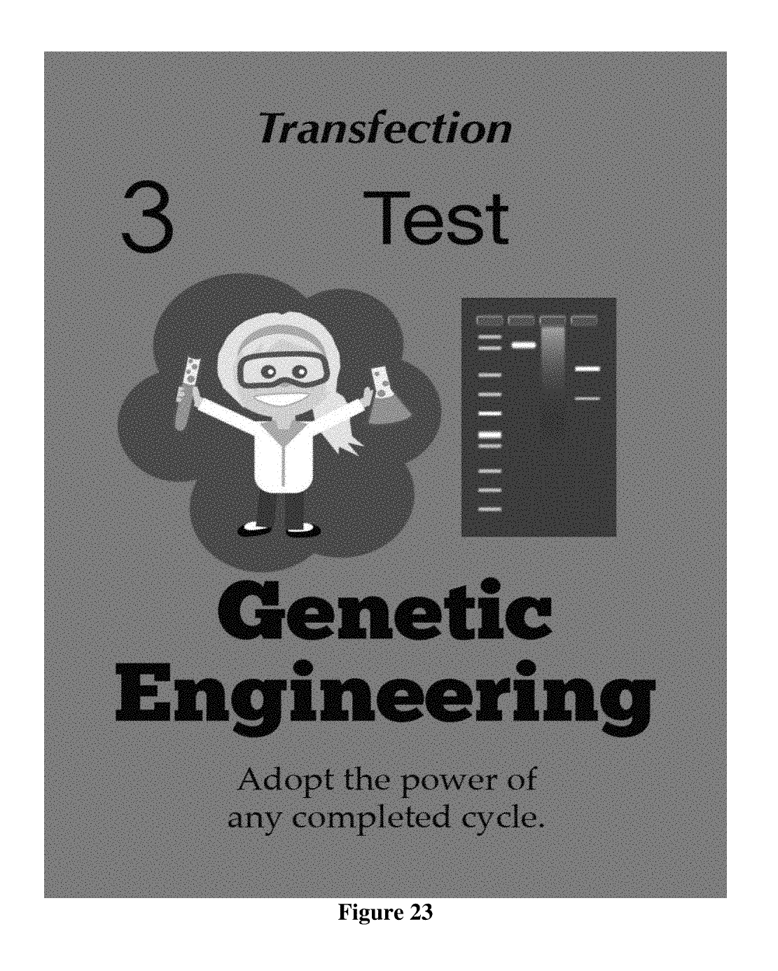

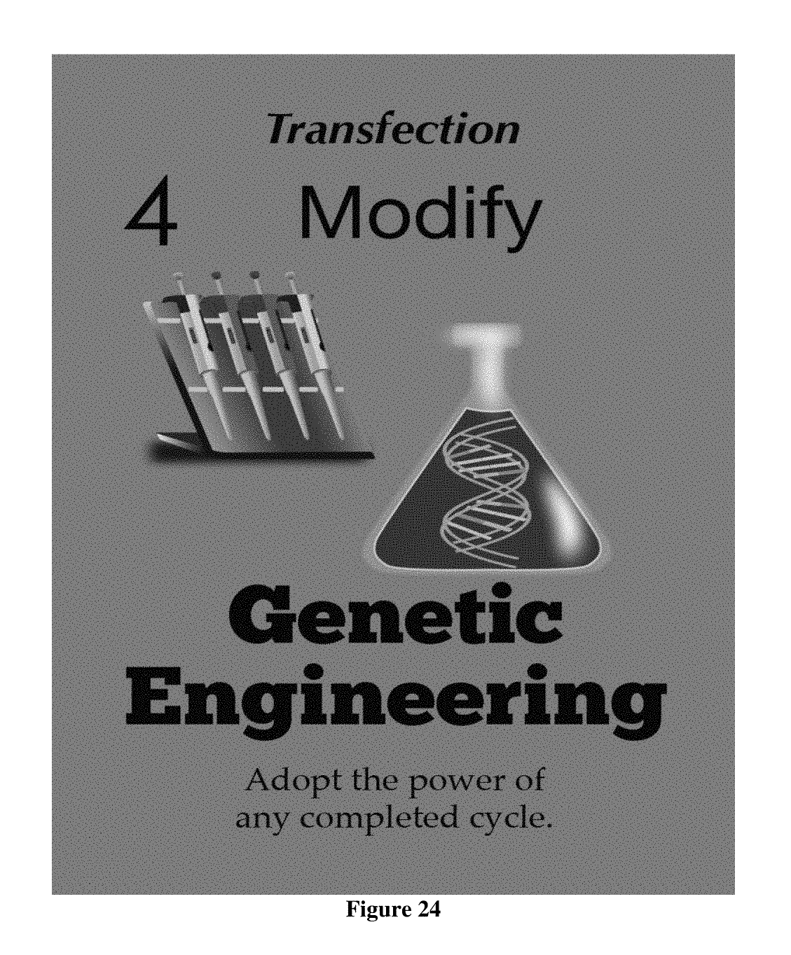

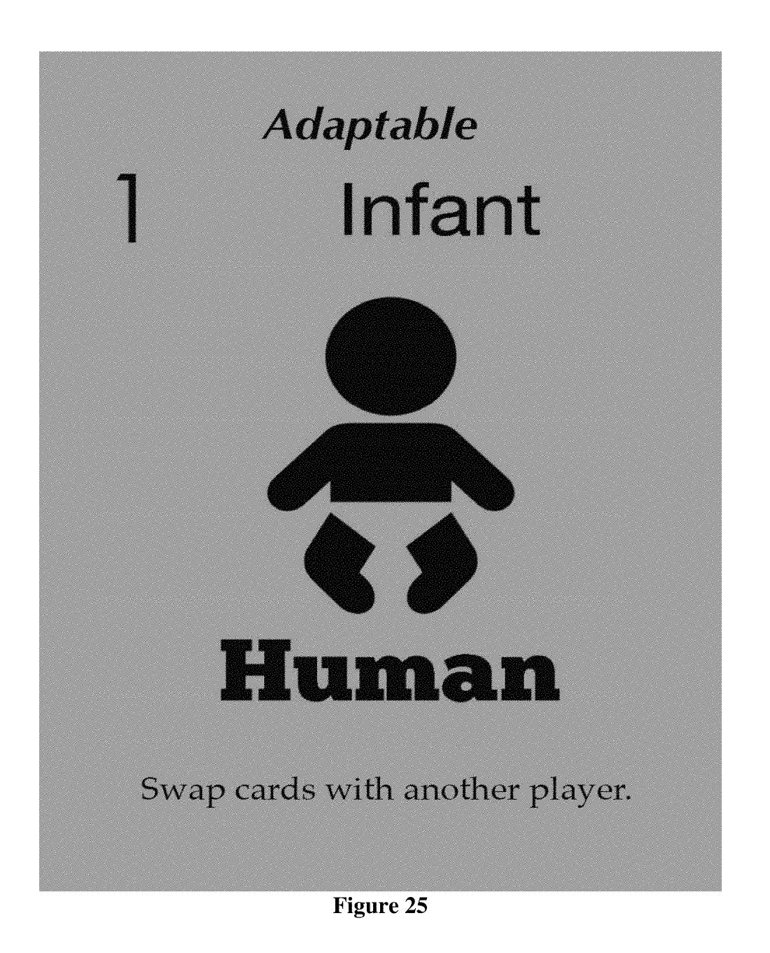

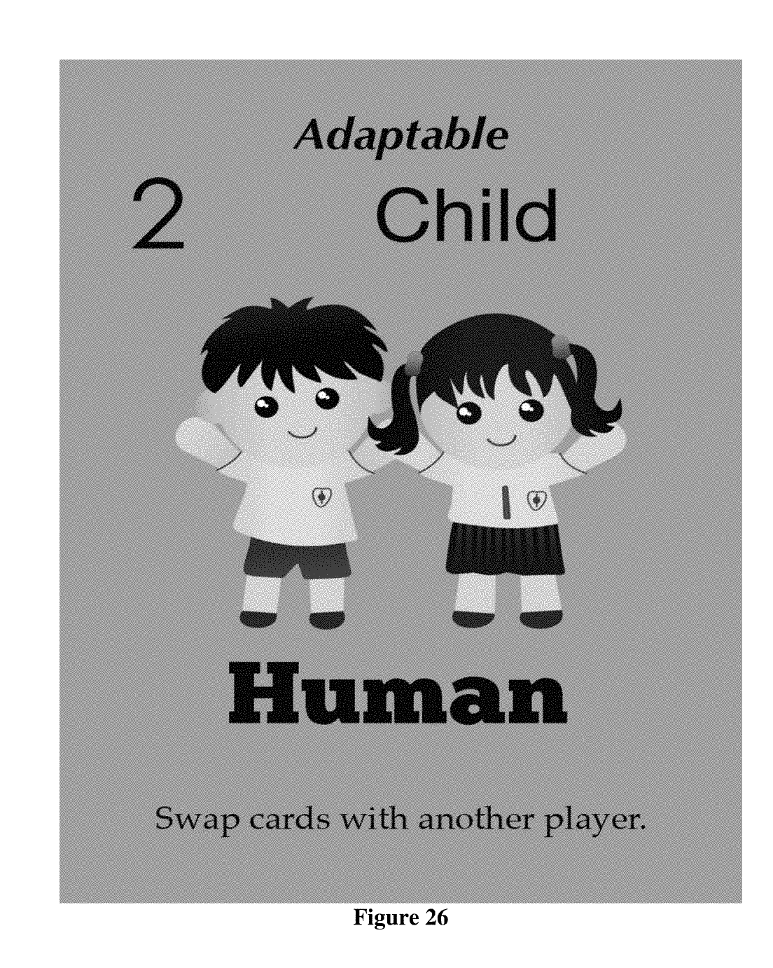

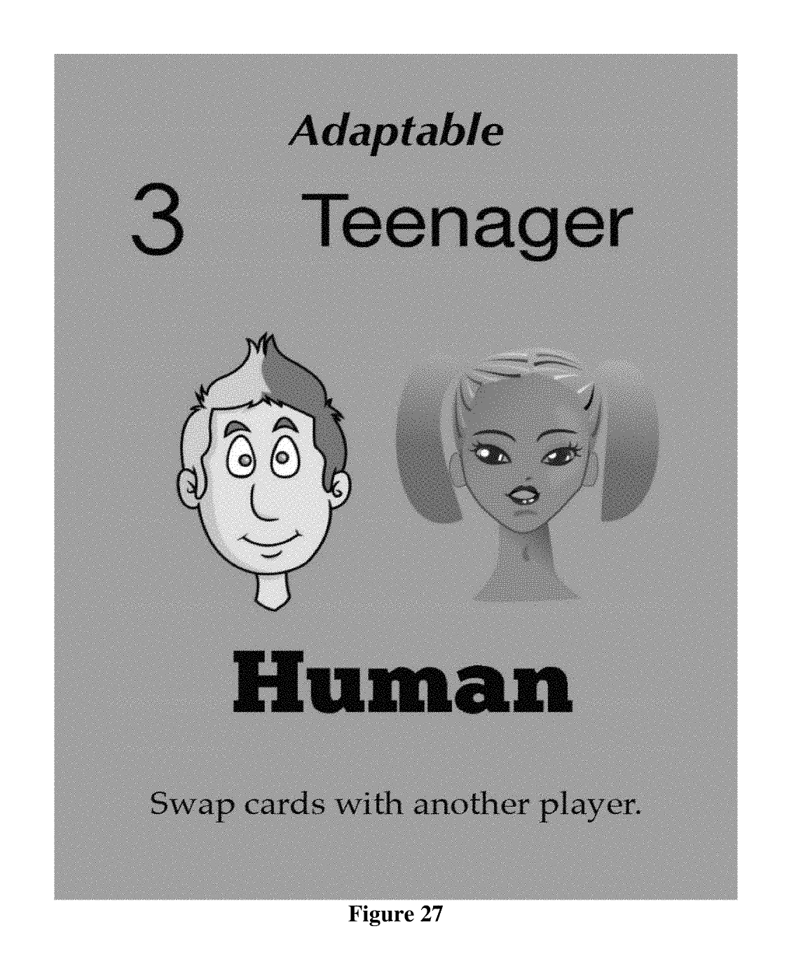

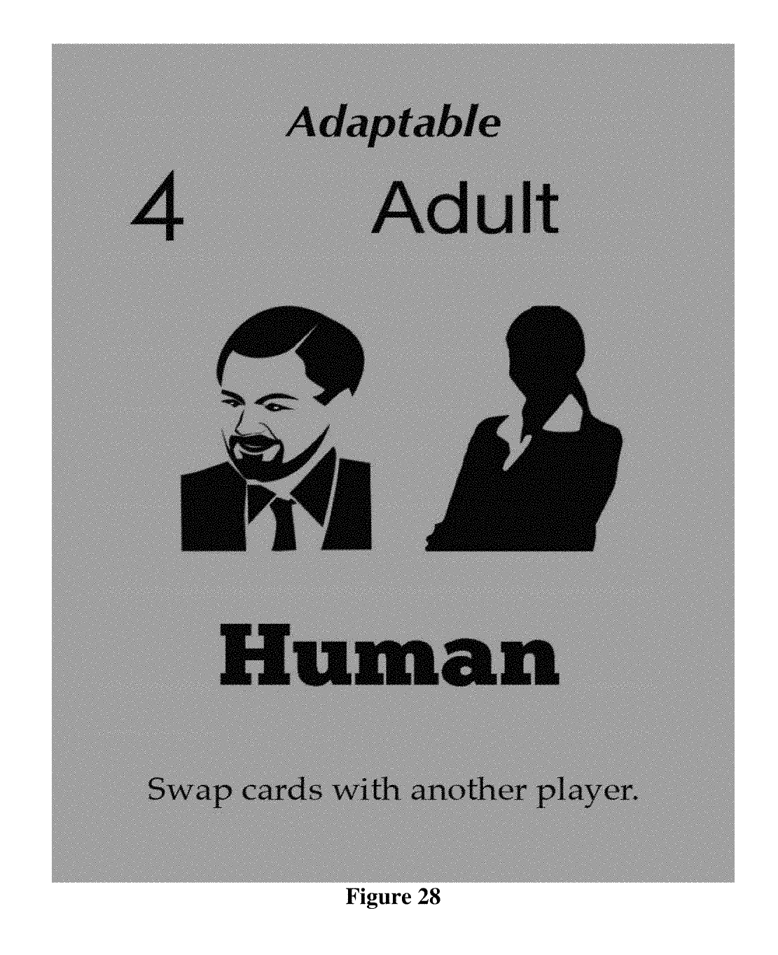

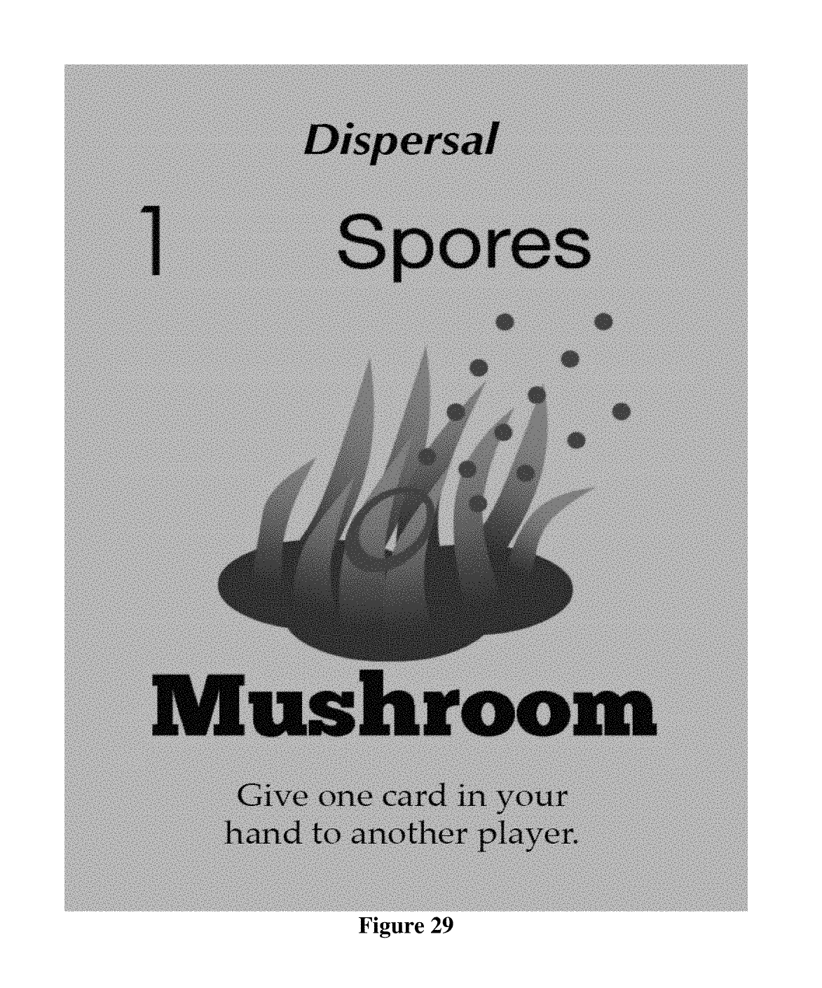

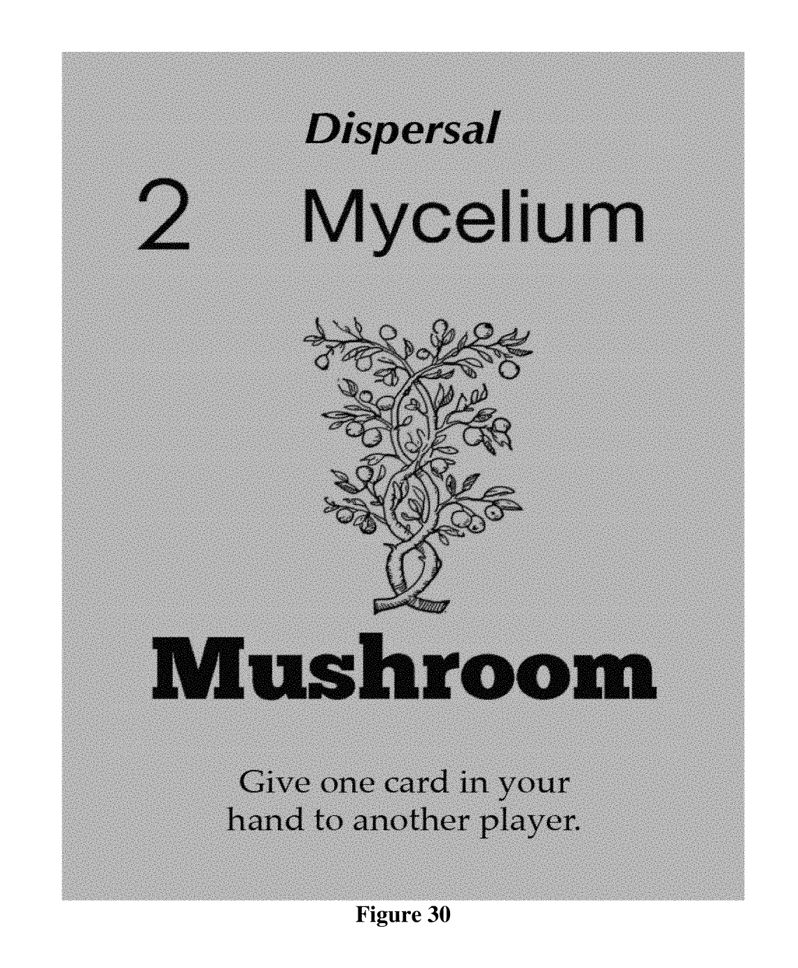

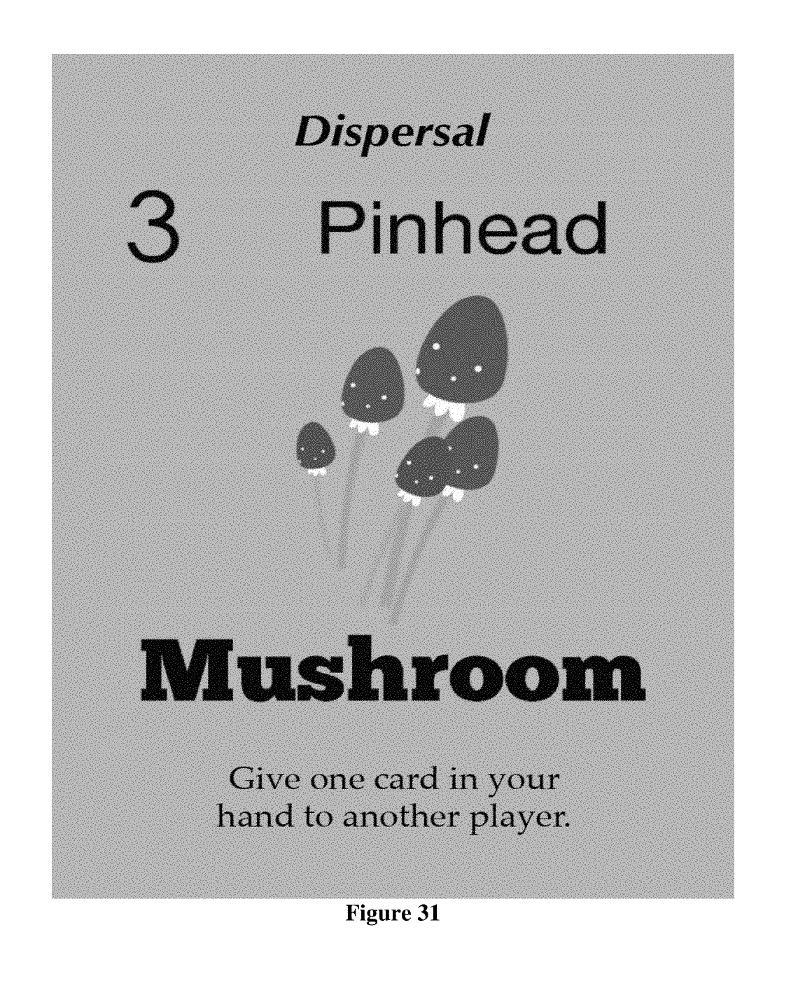

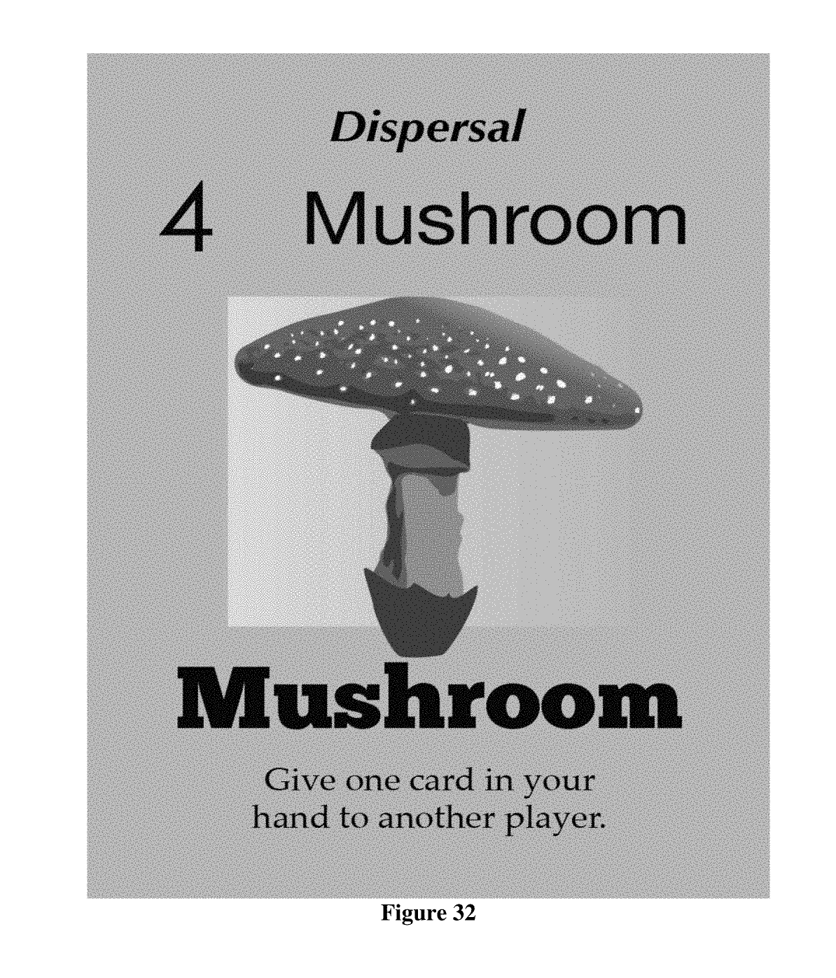

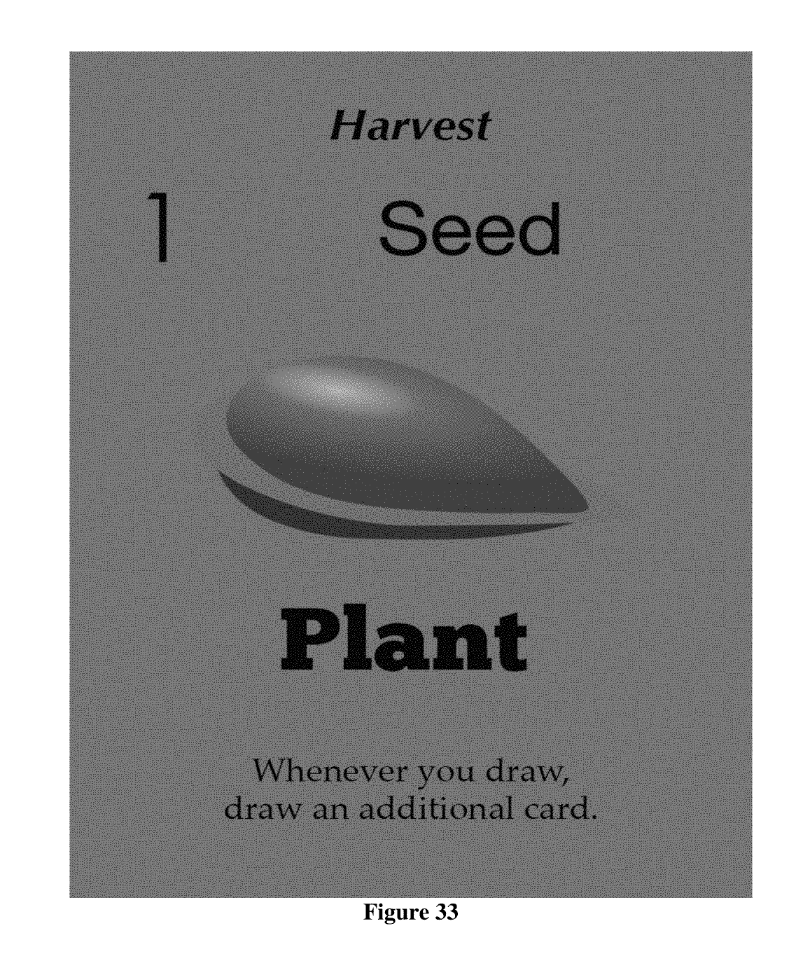

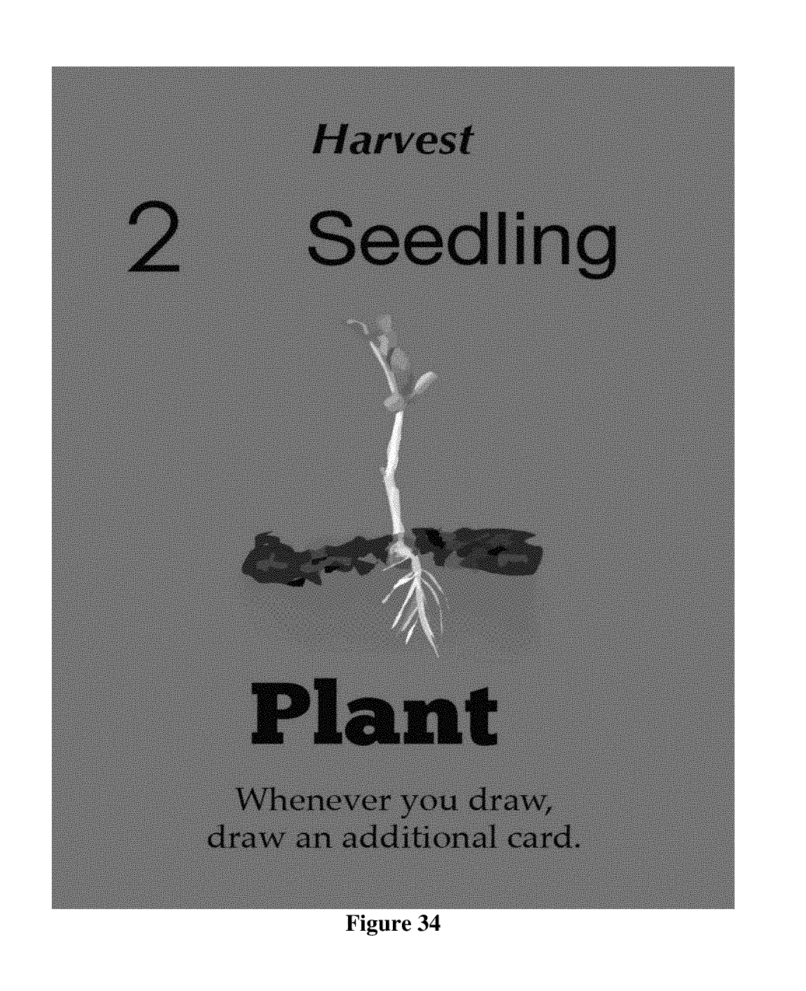

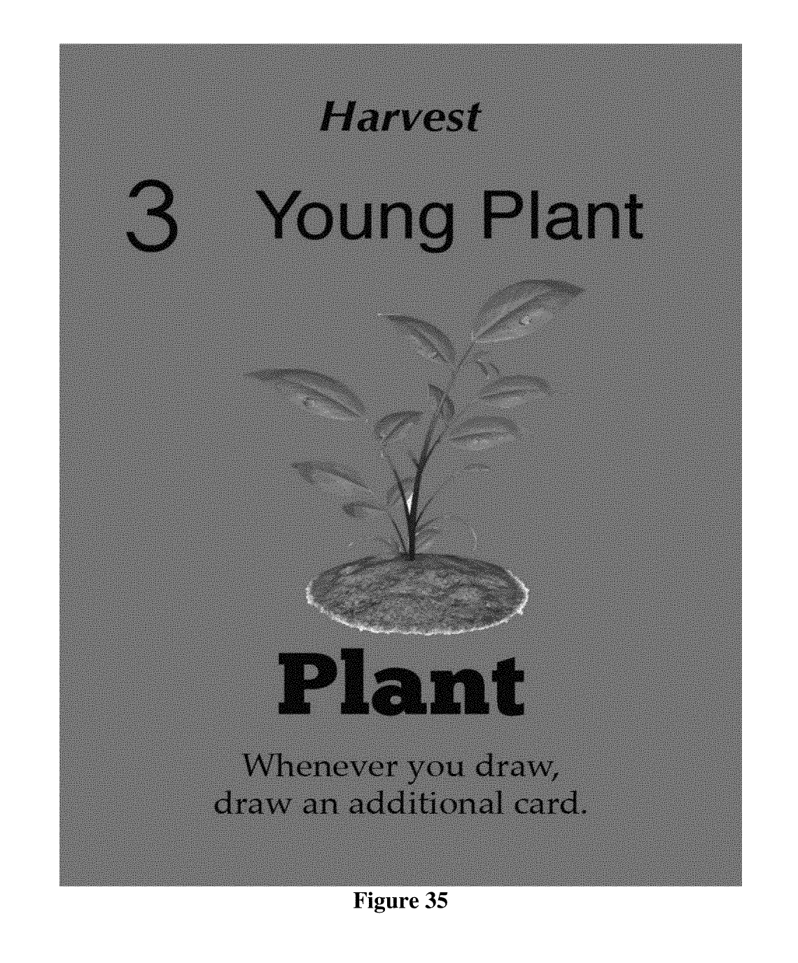

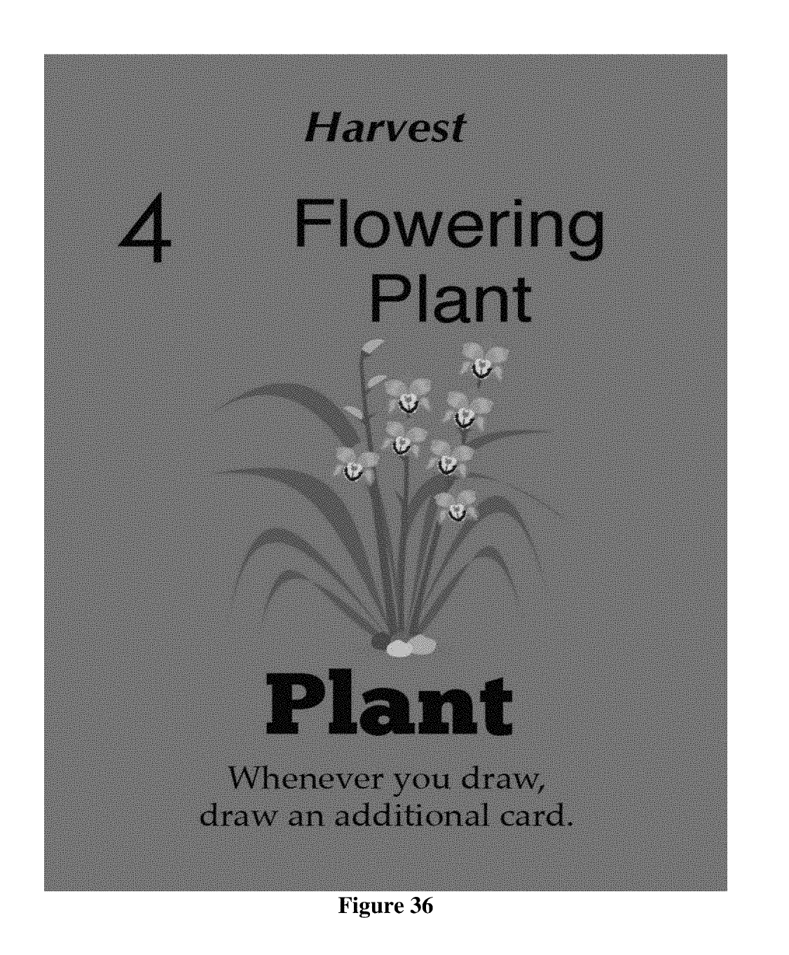

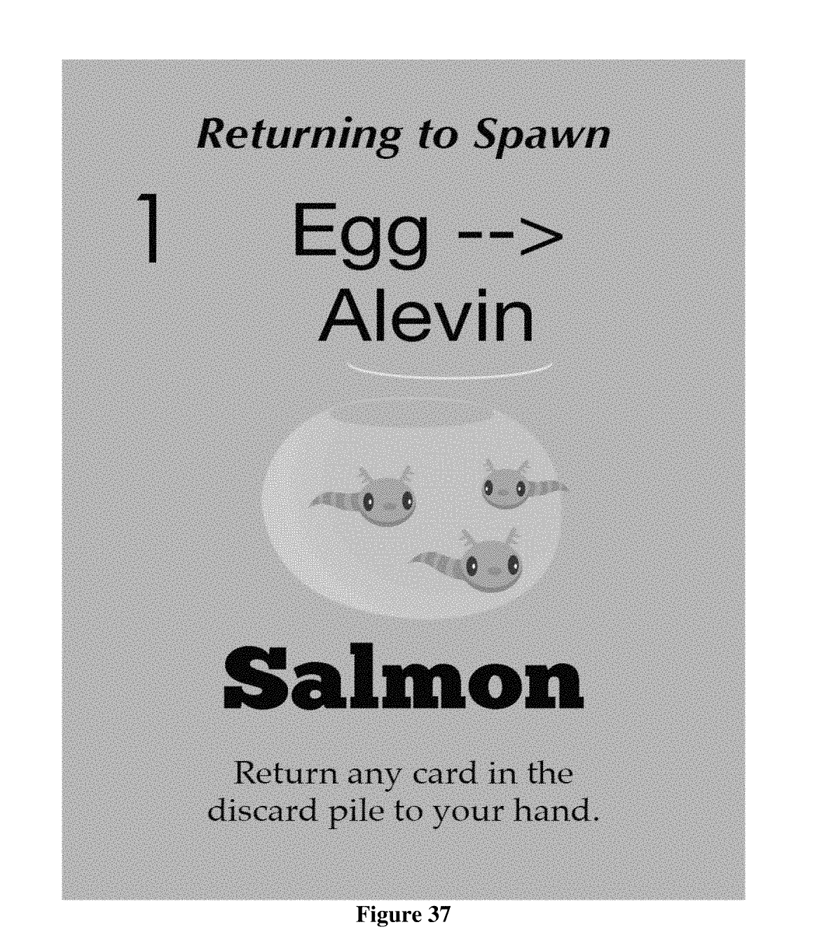

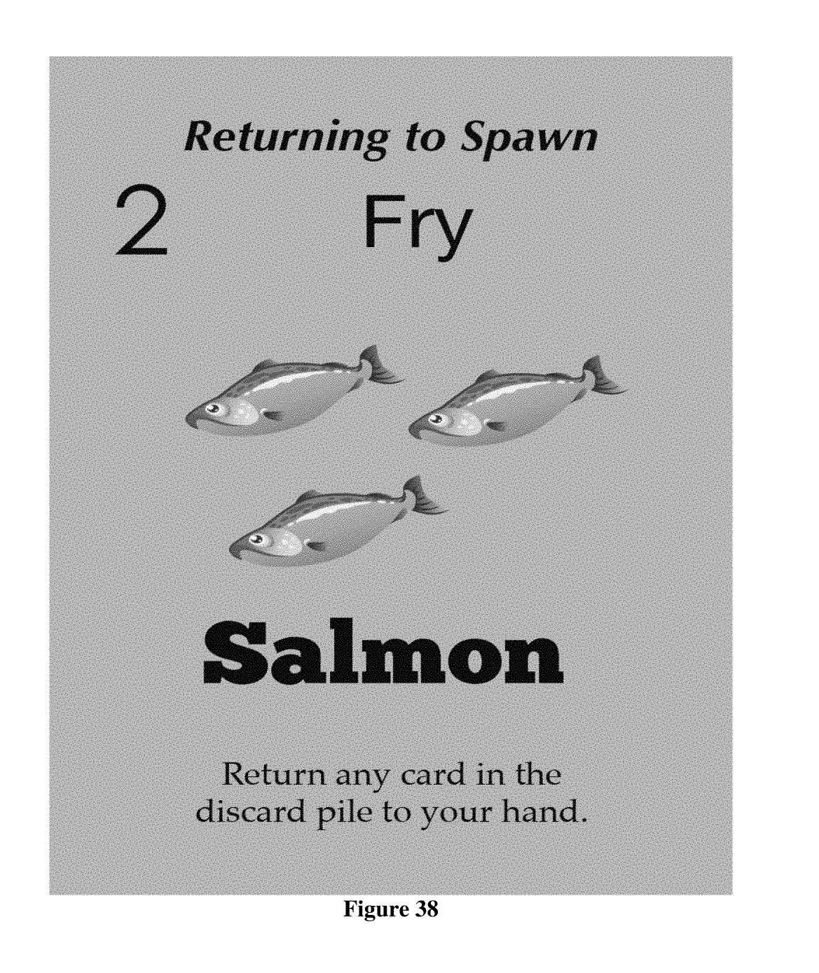

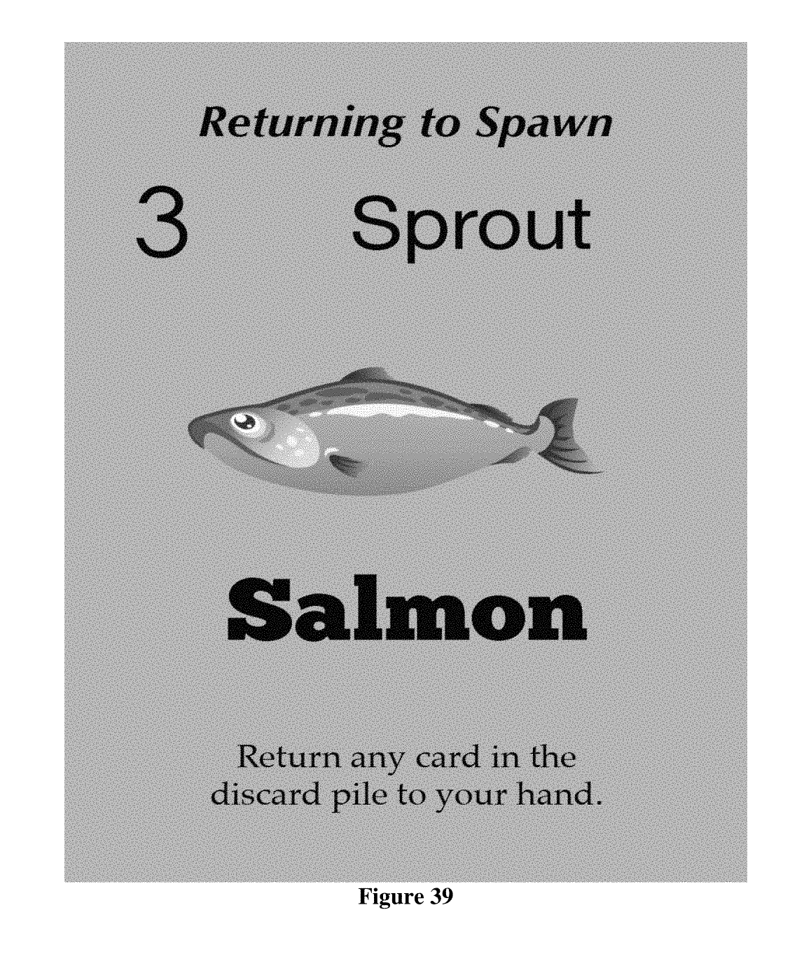

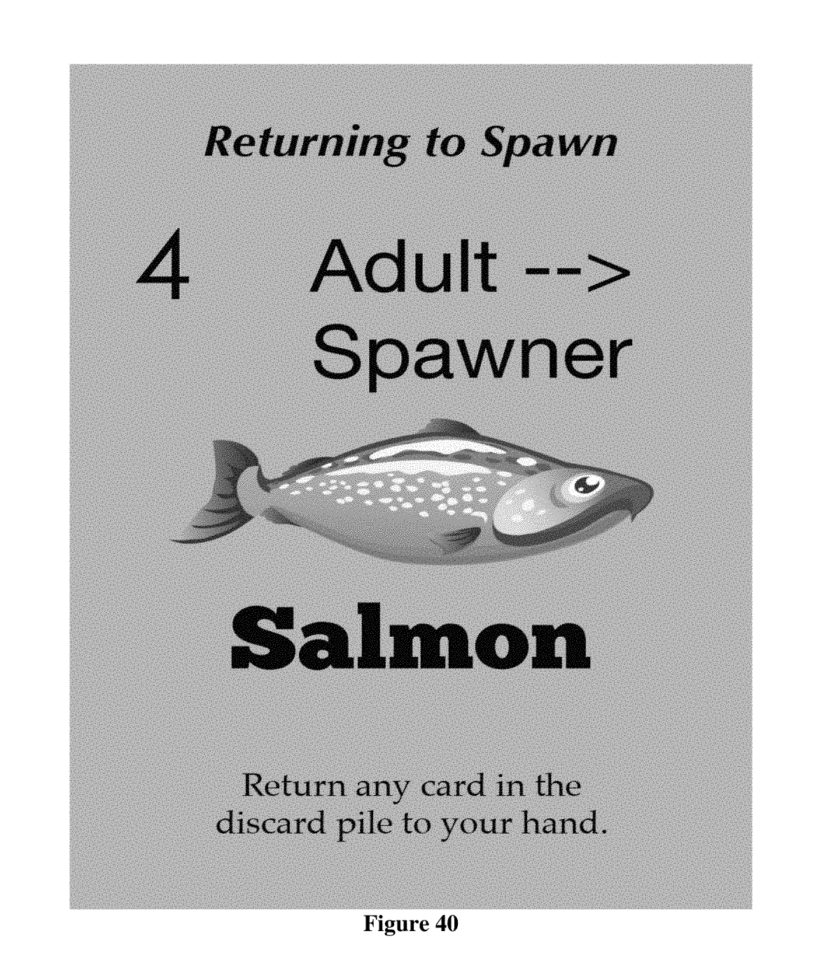

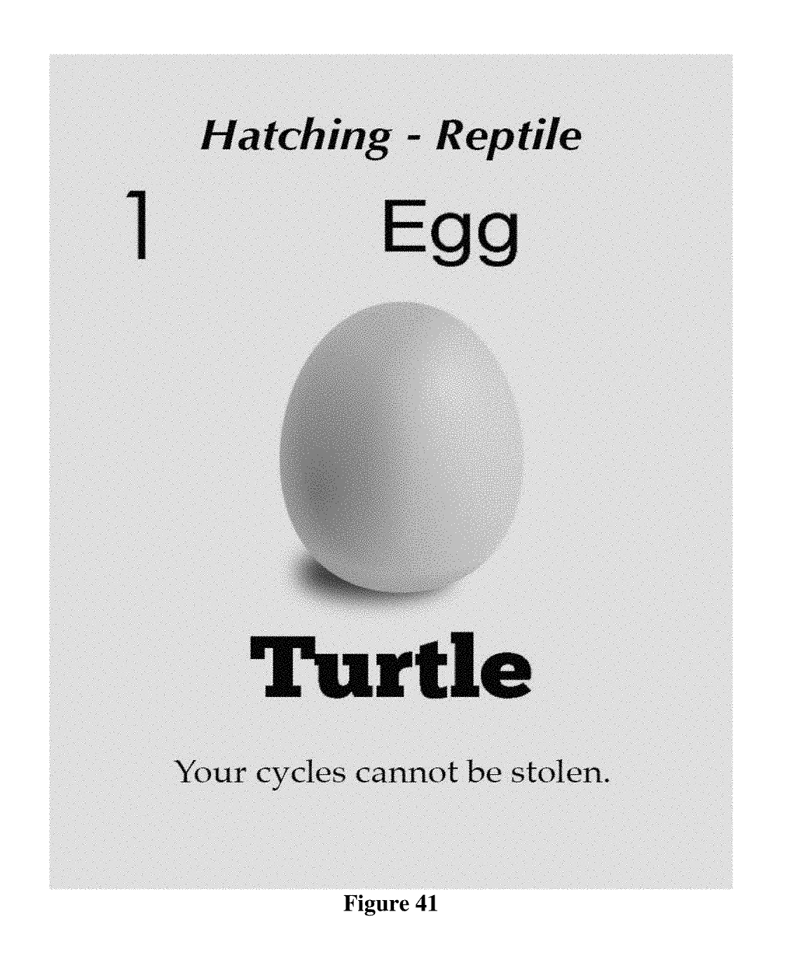

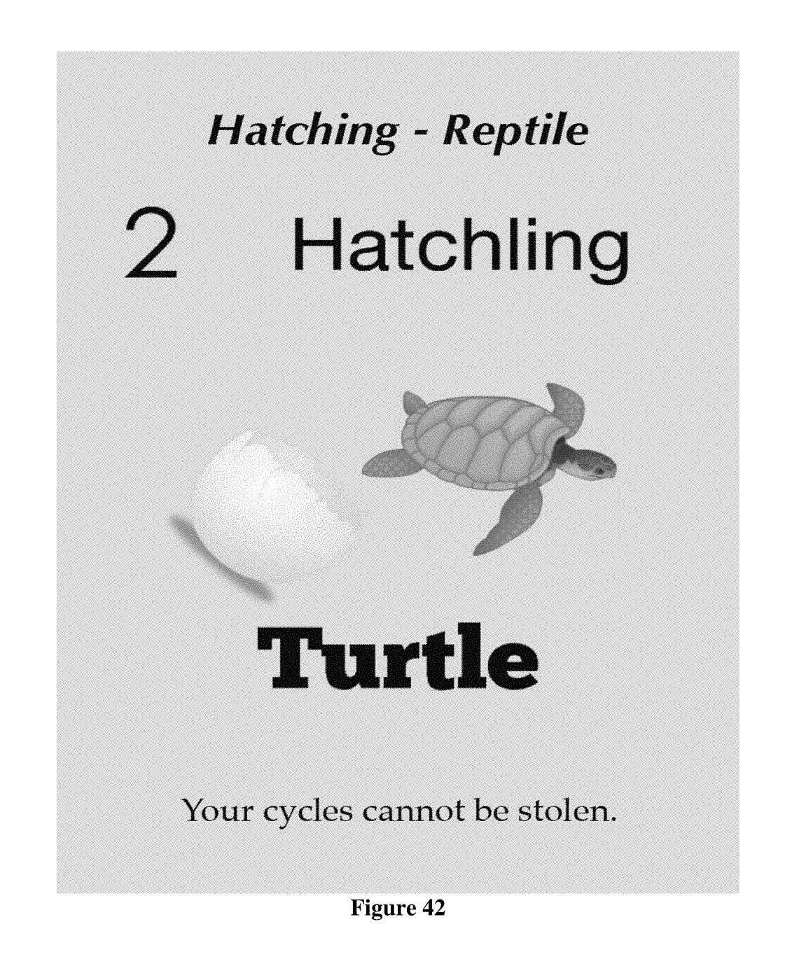

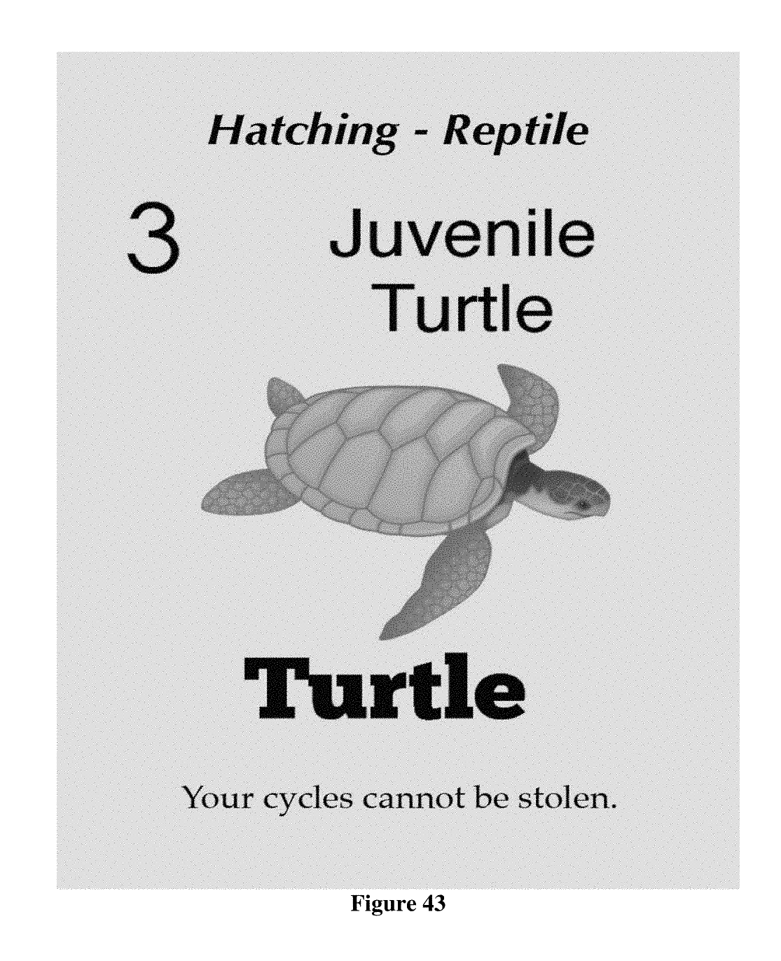

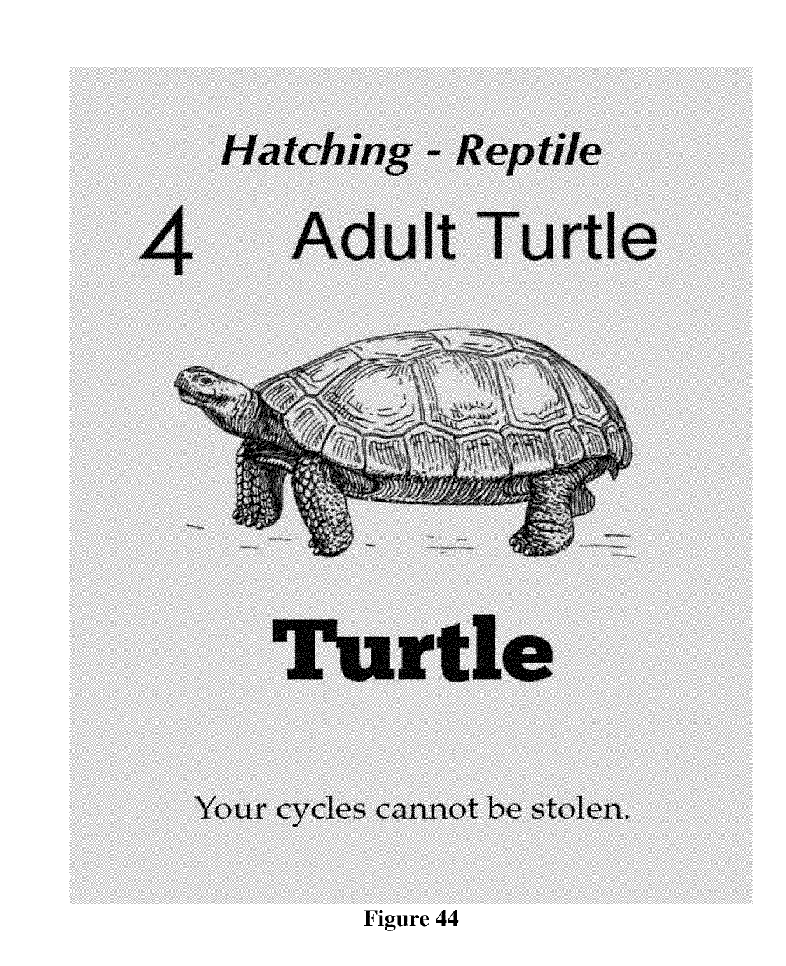

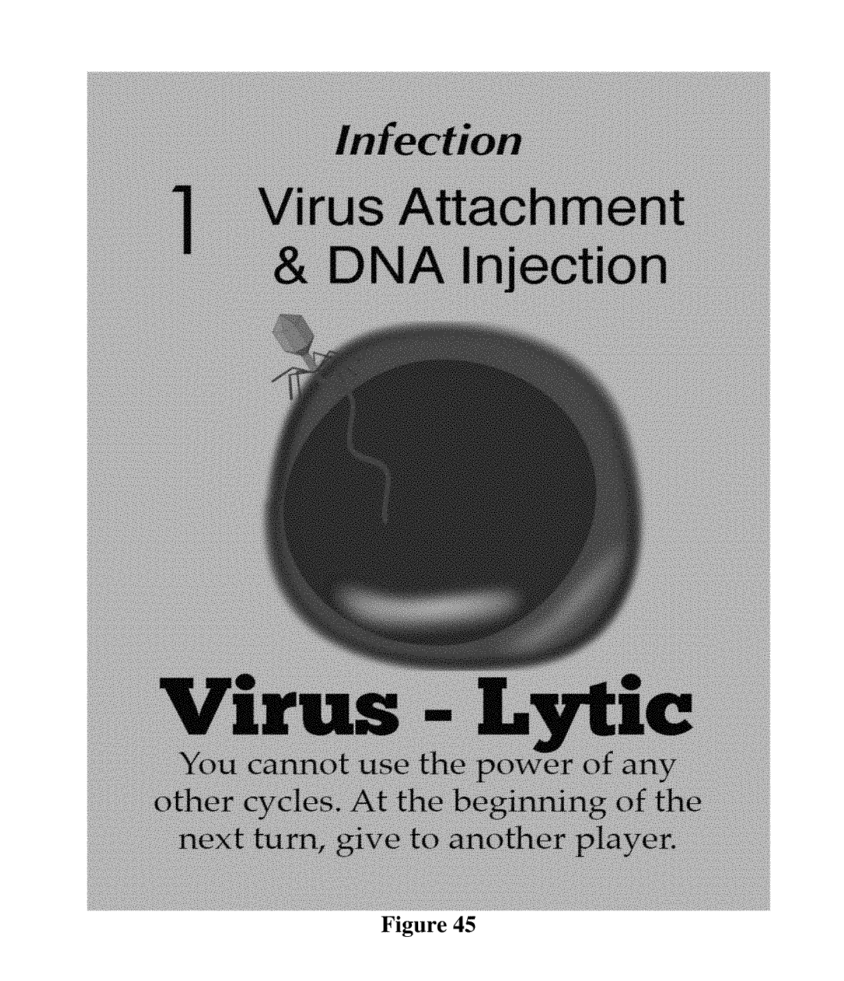

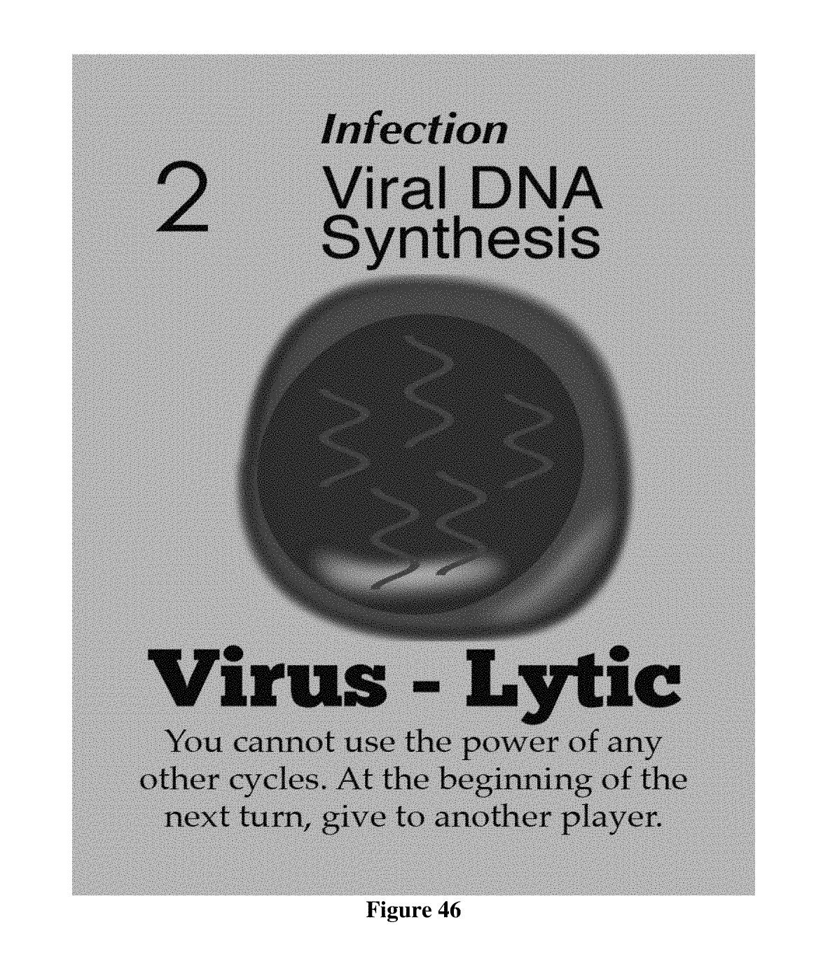

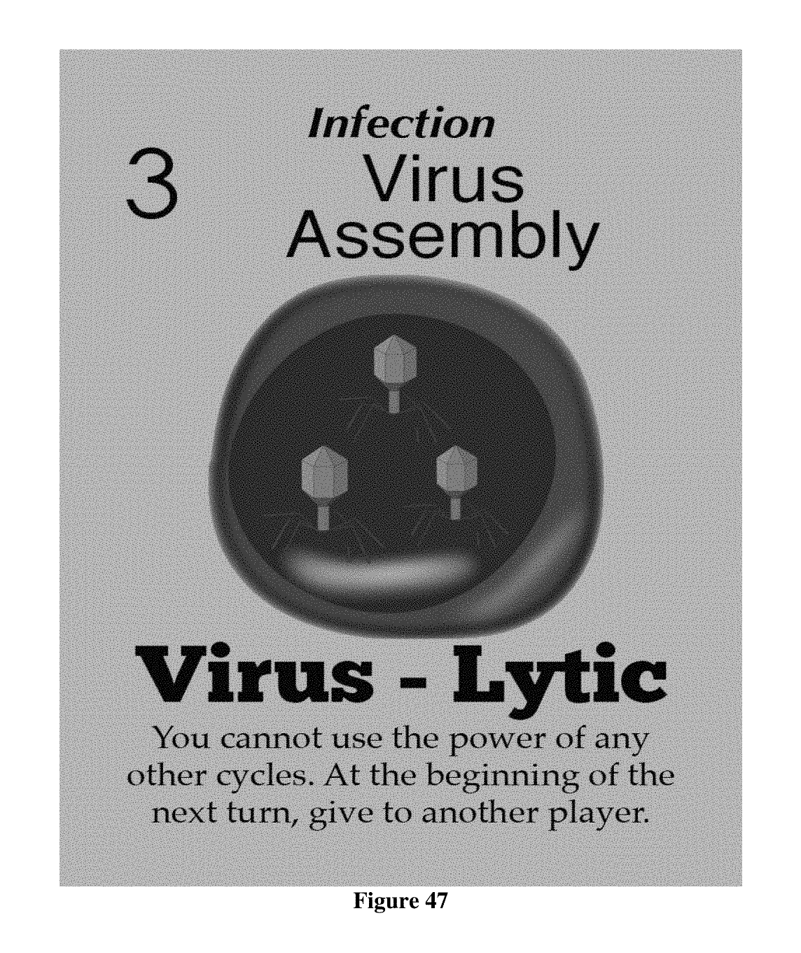

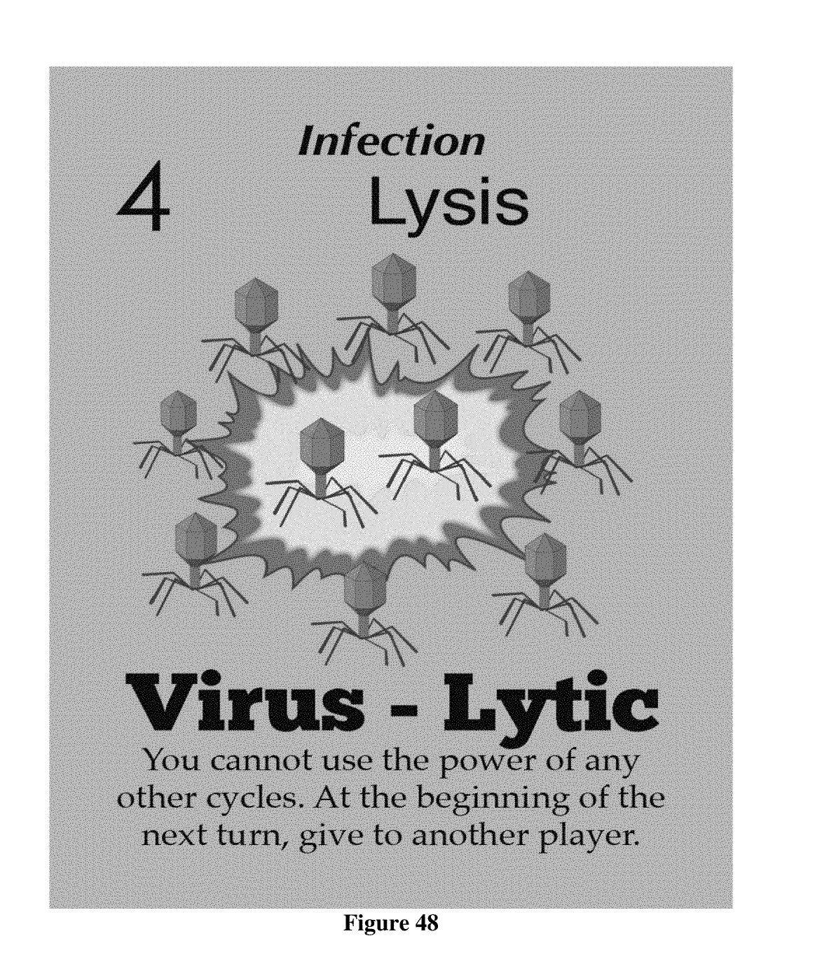

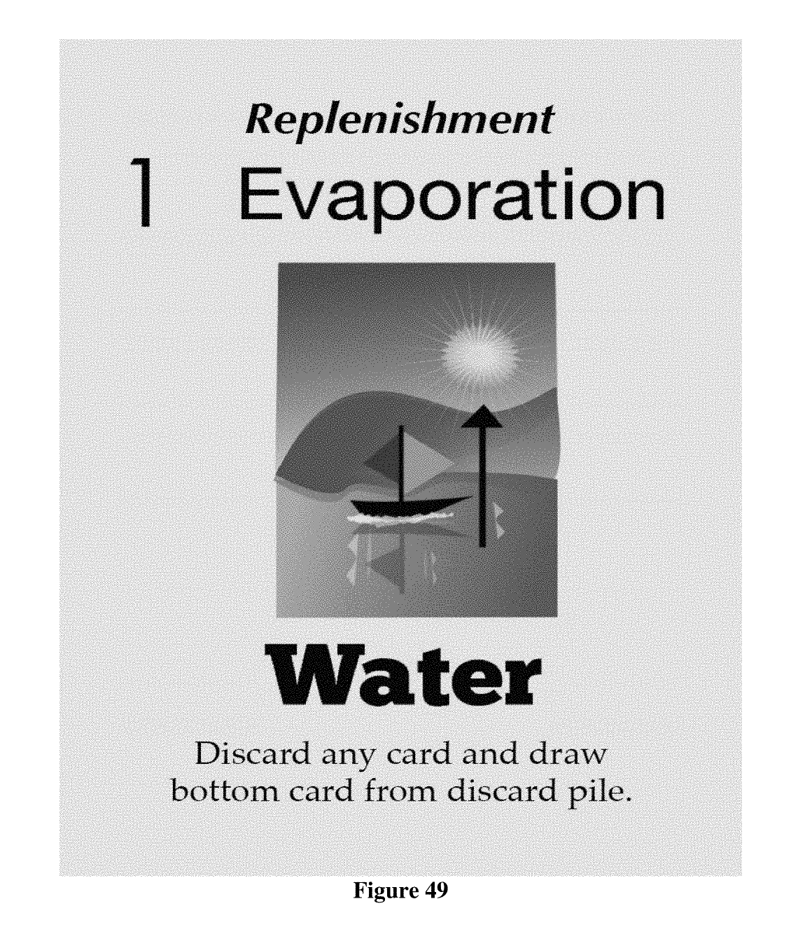

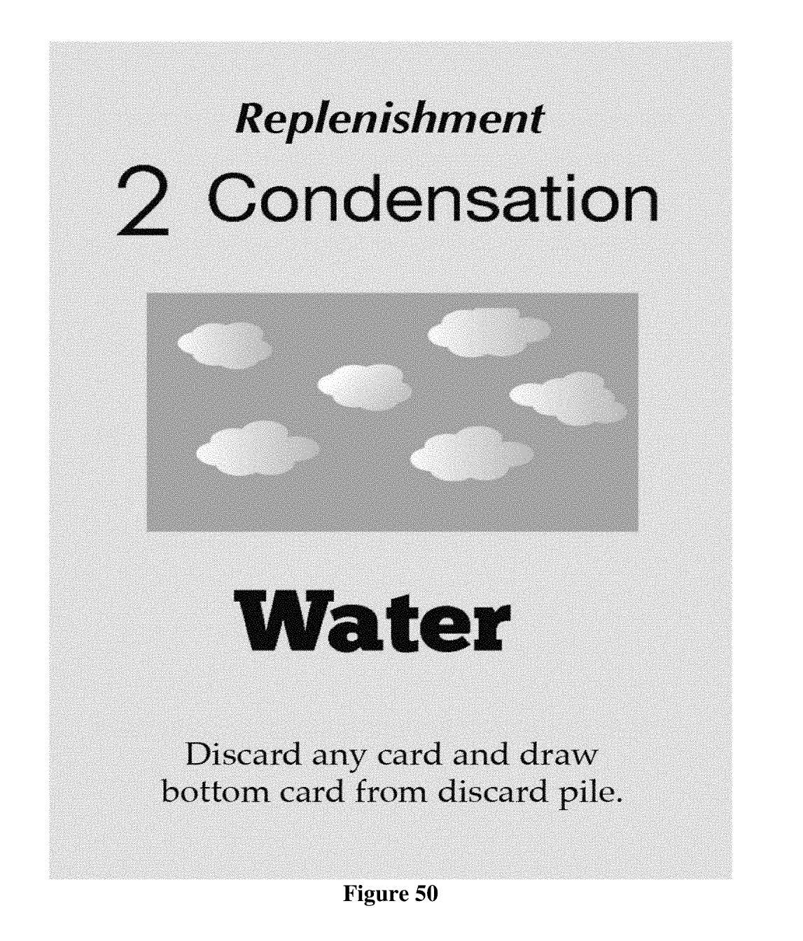

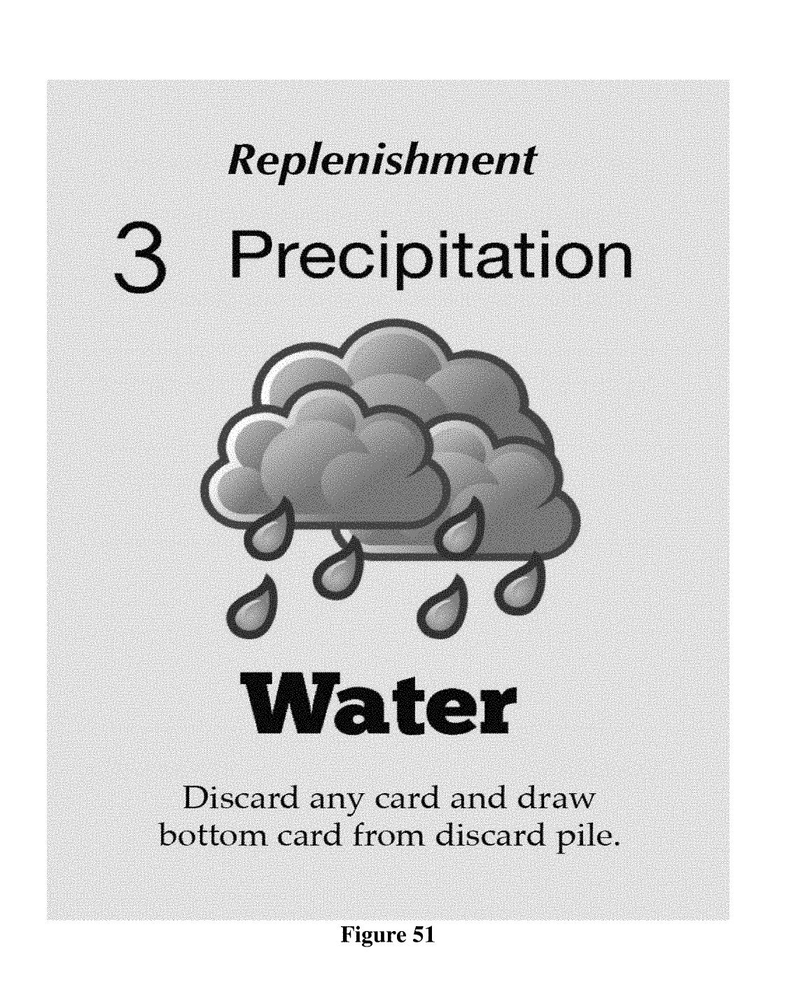

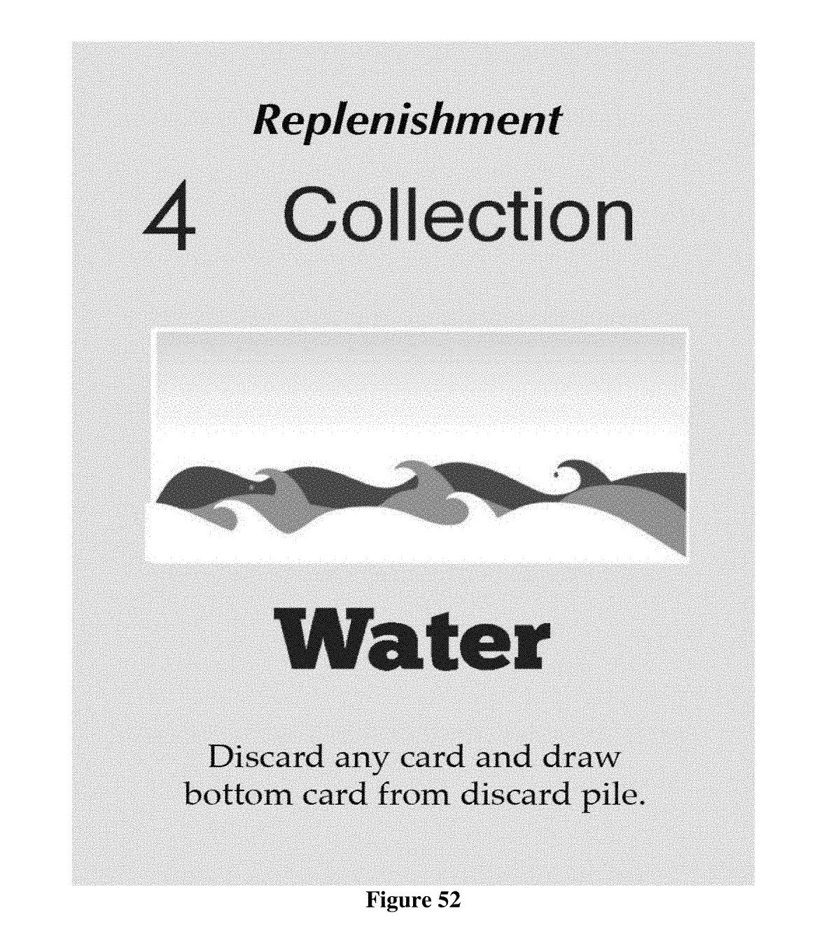

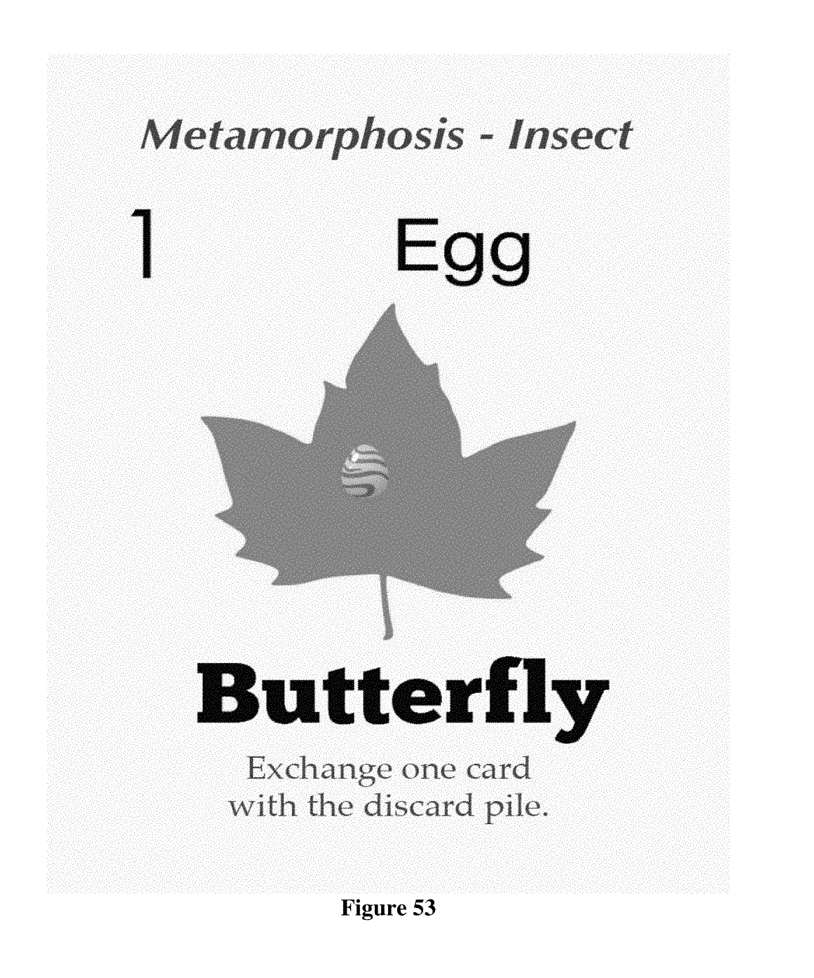

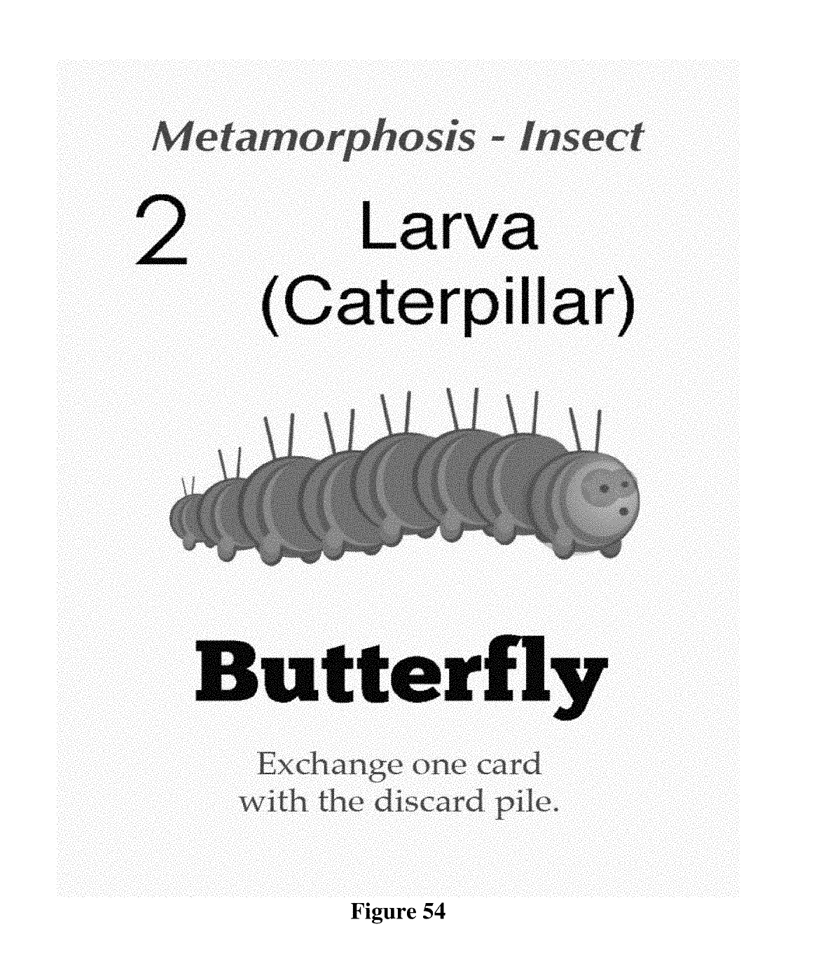

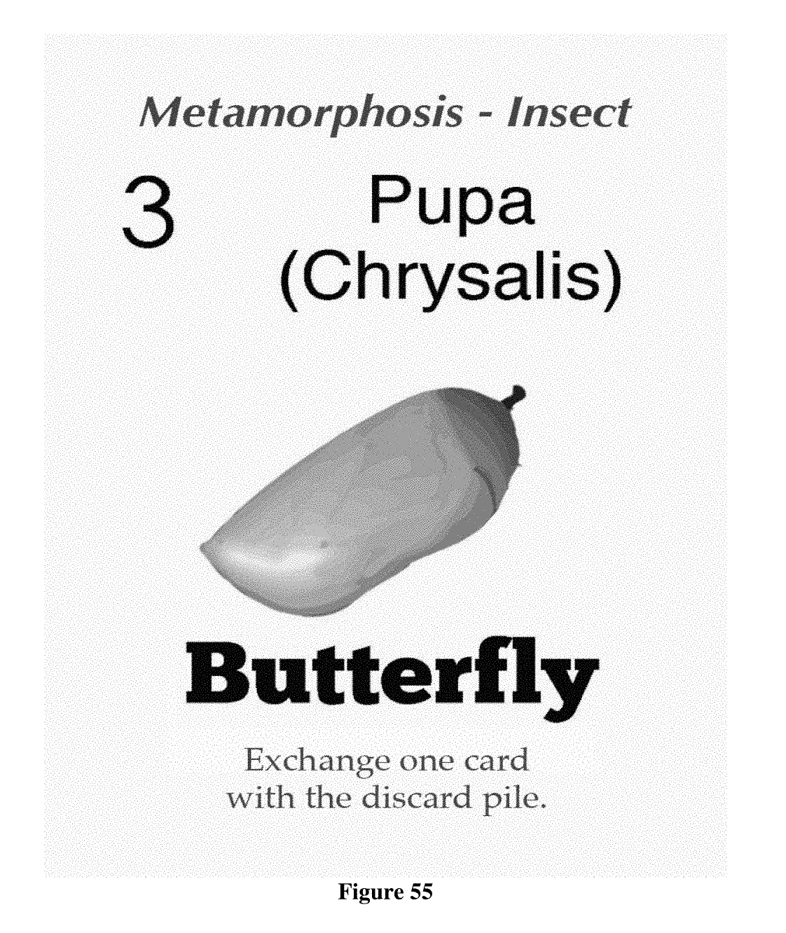

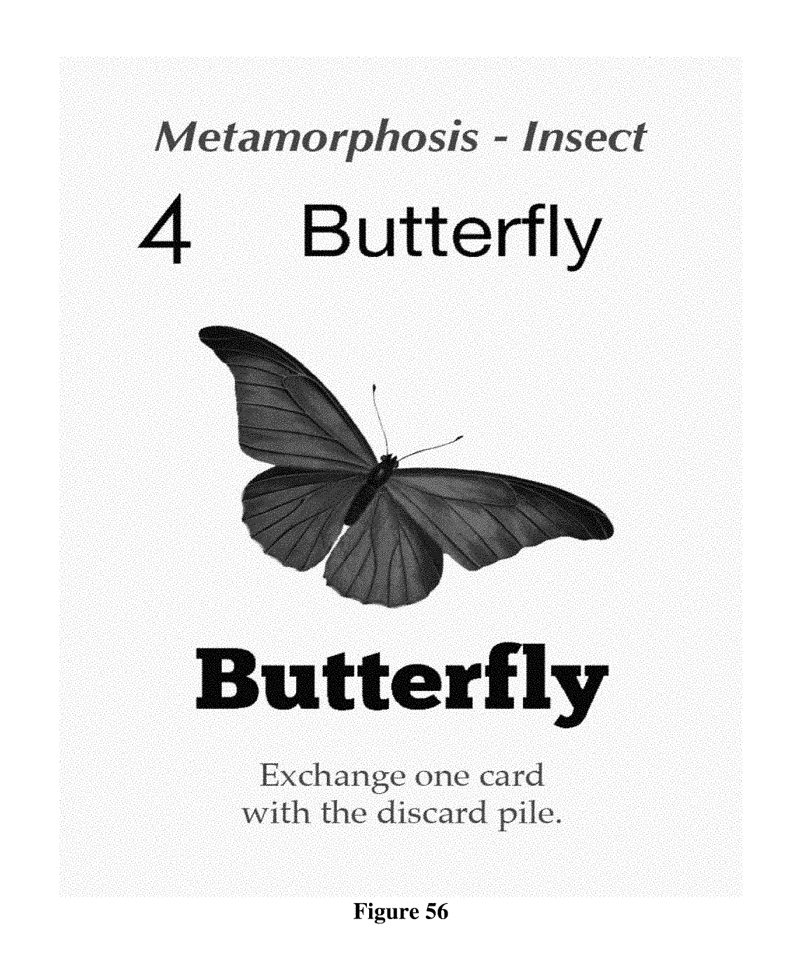

As one example depicted in FIGS. 53-56, the Item X 200₁₋₄ of the first set may be a butterfly. Cycle stage 1 indicator 203₁ may be “egg” and picture 1 204₁ may be a picture of an egg. Cycle stage 2 indicator 203₂ may be “Larva” (caterpillar) and picture 2 204₂ may be a picture of a larva/caterpillar. Cycle stage 3 indicator 203₃ may be “Pupa” (Chrysalis) and picture 3 204₃ may be a picture of a Pupa/Chrysalis. Cycle stage 4 203₄ may be a butterfly and picture 4 204₄ may be a picture of a butterfly. In this example, the cycle descriptor 20₁₋₄ may be “Metamorphosis” and the power indicator 206₁₋₄ for the set may be the ability to “exchange one card with the discard pile.” In this case the power of the set relates to the ability to “change” (or exchange) which illustrates a feature related to the cycle (metamorphosis). As another example depicted in FIGS. 5-8, a second set of cards may relate to a cell. The stages of the cycle 203₁₋₄ may include G1 Phase, S Phase, G2 Phase and Mitosis→Cytokinesis stage, the cycle descriptor 205₁₋₄ may be “Splitting”, and the power indicator 206₁₋₄ for the set may be the ability to “draw two new cards whenever you discard.” The concept of splitting and drawing 2 new cards is functionally related. Other examples of items, cycles and powers are provided herein and depicted in FIGS. 9-52.

The game cards may each be the same size (e.g., the size of a standard deck of poker-size or bridge-size playing cards). One side of the cards may have a common ornamental, non-functional design. The other side may include the functional format of the various indicia described herein. Other variations of the game card indicia may be used without departing from the spirit and scope of this disclosure.

The sequential cycle stage numbers of the cards (1-4) of a set correspond to a corresponding number of sequential stages (stage 1-4) of the cycle for that item.

Some exemplary cycles may include the life cycle of: a butterfly; a frog; a chicken; a human; a salmon; and/or a turtle, the nature cycle of: a cell; water; a plant; mushrooms; and/or viruses, and a genetic engineering cycle. Other life cycles, nature cycles, and/or genetic engineering cycles may be used without departing from the spirit and scope of this disclosure. Cycles comprising greater or less than four sequential portions may be used. For a given deck, the various sets may each have the same number of cards/cycles.

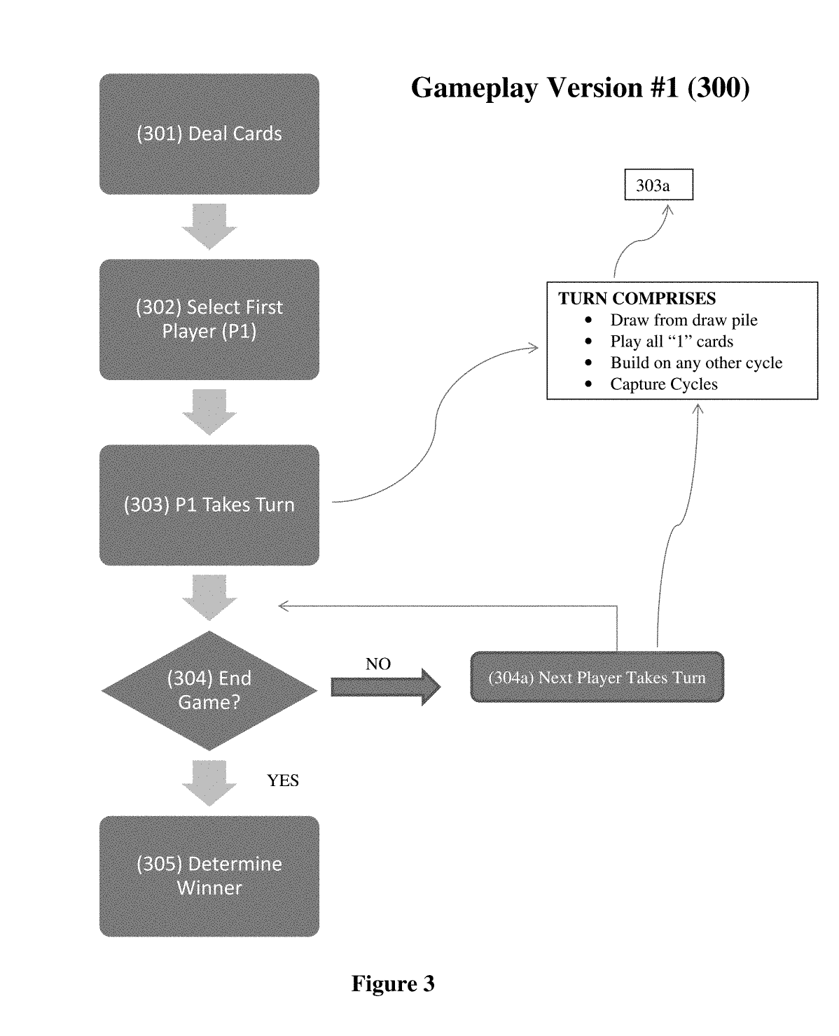

According to one aspect of the invention depicted in FIG. 3, a first method of game play 300 may be in accordance with a first set of rules. According to another aspect of the invention a second method of play 400 may be in accordance with a second set of rules. According to some aspects of the invention the different methods of play may include using different elements of the cards 100 and/or using similar elements in different ways.

The first set of rules may be associated with a first group of players (based on an age group, ability level or other grouping criteria) and the second set of rules may be associated with a second group of players (based on an age group, ability level or other grouping criteria).

In a first method of gameplay (FIG. 3), each game player is dealt (step 301) three cards from the deck of game cards 100 and the cards are placed face up in front of the player. Alternatively, players may hold their game cards in their hands, so as to hide the indicia printed on the game cards from the other players. The remaining game cards will be placed face down in the gameplay area and serve as a pile from which game cards will be drawn from round to round. Once the initial cards are dealt, gameplay may begin with the youngest player going first (step 302). Other methods of selecting the first player to start the gameplay may be used without departing from the spirit and/or scope of the disclosure. On a player's turn (step 303), the player takes a turn according to the rules. For example as shown in step 303a, the player may draw one game card from the draw pile and play one or more cards from the players hand as follows: for any item for which no card has yet been played, play the cycle 1 card for that item (if the player has it) by placing it face up in the gameplay area; for any item for which one or more cards has been played, play the next sequential card in the cycle for that item by placing it face up in the vicinity, e.g., next to, on top of, of the played sequence, thereby continuing the sequence. By sequentially placing the cards for an item, the players see and ideally learn the various sequential stages of the cycle for that item.

Further in accordance with the rules for the first method of gameplay 300, if a player has laid down the fourth (or last) game card (i.e., the game card with the last cycle stage indicia for a given set) of the cycle for an item, the cycle is considered captured (i.e., won) by that player and may be taken and placed in front of that player. The game proceeds in this manner, with players taking turns as described herein in an orderly manner, until the conclusion (step 304) (e.g., all of the cards have been placed face up in the gameplay area and all cycles have been captured, until a player runs out of cards, or other conclusion). In this method of gameplay, the player who captures the most cycles is determined to be the winner (step 305). Other scoring techniques can be used.

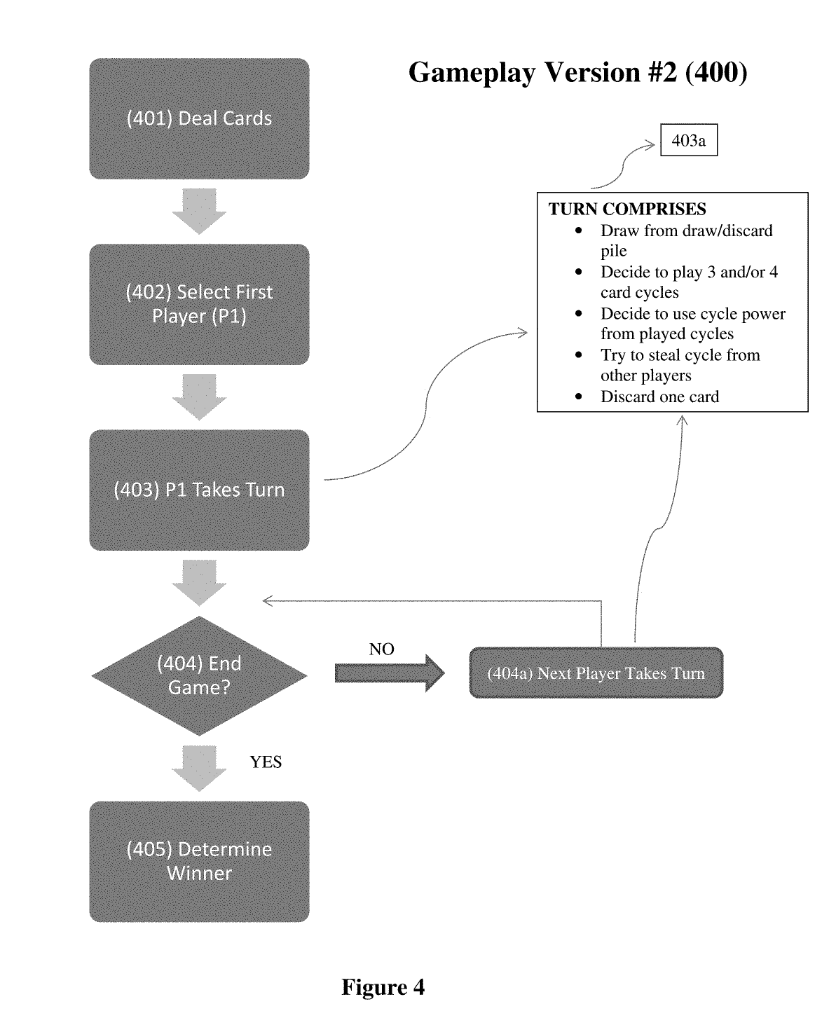

In a second method of gameplay, depicted in FIG. 4, each game player is dealt (step 401) seven cards from the deck of game cards 100 and are kept hidden in the hand of the player. All of the remaining game cards will initially be placed face down in the gameplay area, except for the top game card, and serve as a pile from which game cards may be drawn from round to round. The top game card will be turned face up, placed next to the draw pile, and serve as the discard pile. Once the initial cards are dealt, gameplay may begin with the youngest (or other) player going first (step 402). On a player's turn (step 403), the player takes a turn according to the rules. For example as shown on step 403a, the player may draw one card from either the draw pile or the discard pile, determine whether they have at least three sequential game cards of a set for an item, e.g., three cards for item butterfly with cycle stage numbers 1, 2, and 3. For any 3 or 4-card sets the player has and may wish to play, according to a strategy of the player, the player may place the cards face up in front of the player. According to one method of play, when the player places such cards, the player may use the powers indicated by those cards (e.g., by the power indicator (106) printed on the cards). The player may then discard one game card from the remaining cards in the player's hand by placing it face up in the discard pile so that the game cards in the discard pile remain visible. In another method of gameplay, a restriction may be imposed whereby a player who draws a card from the discard pile must play the card immediately by placing a 3 or 4-card set face up in front of them. On a player's turn, the player may steal a cycle from another player if the player has the fourth (or final) game card of a set. The completed four-card set may then be placed in front of the player who made the steal.

The game proceeds in this manner, with players taking turns as described herein in an orderly manner, until the conclusion (step 404) (e.g., all of the cards have been placed face up in the gameplay area and all cycles have been captured, until a player runs out of cards, or other conclusion). In this method of gameplay, the player who captures the most sets is determined to be the winner (step 405). One set capture may be considered to be worth one point, however any suitable scoring mechanism may be used to value a captured set. In an instance where two or more winning players have the same number of sets (i.e., the same number of points), a tiebreaker rule may be instituted in any suitable manner (e.g., four-card sets are worth two points, three-card sets are worth one point).

The foregoing detailed description of the invention has been presented for purposes of illustration, and is not intended to be exhaustive or limited to the invention in the form disclosed. Variations and modification of the embodiments described herein will be apparent to those of ordinary skill in the art, and it is understood that the invention may be practiced in a manner other than what is specifically described herein without departing from the spirit and/or scope of the disclosure.

What is claimed is:

1. A card-game system comprising:
a deck of cards, wherein the deck of cards further comprises:
a first set of cards, wherein the first set of cards is associated with a first item, a first cycle associated with the first item, and a first gameplay power associated with the first cycle, and includes:
a plurality of cards, wherein each card has printed thereon, multiple indicia including an first item identifier, a first cycle descriptor, a first cycle stage number indicator, a first cycle stage descriptor, and a first power indicator, wherein the first item identifiers for the plurality of cards match, and wherein the first cycle stage number indicators for the plurality of cards are sequential;
a second set of cards, wherein the second set of cards is associated with a second item, a second cycle associated with the second item, and a second gameplay power associated with the second cycle, and includes:
a plurality of cards, wherein each card has printed thereon, multiple indicia including a second item identifier, a second cycle descriptor, a second cycle stage number indicator, a second cycle stage descriptor, and a first power indicator, wherein the second item identifiers for the plurality of cards match, and wherein the second cycle stage number indicators for the plurality of cards are sequential; and
a set of rules for instructing players how to play a card game based on the multiple indicia on each of the cards.

2. The card-game system of claim 1, wherein each card in the deck further comprises a cycle stage depiction.

3. The card-game system of claim 1, wherein the first power indicators for the plurality of cards in the first set match and the second power indicators for the plurality of cards in the second set match.

4. The card-game system of claim 3, wherein the matching first power indicators for the plurality of cards in the first set, grant a player a first gameplay ability.

5. The card-game system of claim 1, wherein the set of rules comprises a first version and a second version.

6. The card-game system of claim 5, wherein the first version instructs players to utilize only a subset of the multiple indicia for each card in the deck.

7. The card-game system of claim 6, wherein the second version instructs a player to utilize a power indicator, wherein the power indicator is not included in the subset.

8. A method of playing a card game comprising,
providing a deck of cards, wherein the deck of cards further comprises:
multiple sets of cards, wherein each set of cards comprises a plurality of cards, and is associated with an item, a cycle associated with the item, and a gameplay power associated with the cycle according to a plurality of indicia printed on each of the plurality of cards, wherein the plurality of indicia includes: an item identifier, a cycle descriptor, a cycle stage number indicator, a cycle stage descriptor, and a power indicator;
dealing three cards, from the deck of cards, to a plurality of players;
placing the remaining cards face down in a gameplay area to form a draw pile;
selecting a first player of the plurality of players to take a turn to start the card game;
taking a turn, by the first player, according to a set of rules associated with the card game,
wherein taking the turn comprises a player:
drawing a card from the draw pile,
playing any cards determined to have a cycle stage number indicator representing a first stage of a cycle by placing them face up in the gameplay area,
playing any cards determined to have a cycle stage number indicator representing the next stage of a cycle of a previously played card, and
capturing any set of cards by playing a card representing the last stage of a cycle according to the cycle stage number indicator;
determining whether or not the card game is over;
if the card game is determined not to be over, taking the turn, by a another player; and
if the card game is determined to be over, determining the winner of the card game.

9. The method of claim 8, wherein each card in the deck further comprises a cycle stage depiction.

10. The method of claim 8, wherein determining a winner of the card game comprises selecting the player who captured the most number of cycles.

11. A method of playing a card game comprising,
providing a deck of cards, wherein the deck of cards further comprises:
multiple sets of cards, wherein each set of cards comprises four cards, and is associated with an item, a cycle associated with the item, and a gameplay power associated with the cycle according to a plurality of indicia printed on each of the four cards of each set, wherein the plurality of indicia includes: an item identifier, a cycle descriptor, a cycle stage number indicator, a cycle stage descriptor, and a power indicator;
dealing seven cards, from the deck of cards, to a plurality of players;
placing the remaining cards face down in a gameplay area to form a draw pile;
placing the top card of the draw pile face up next to the draw pile to form a discard pile;
selecting a first player of the plurality of players to take a turn to start the card game;
taking a turn, by the first player, according to a set of rules associated with the card game,
wherein taking the turn comprises a player:
drawing a card from the draw pile or the discard pile,
determining whether to play a cycle of cards;
determining whether to use a power indicated by the power indicator of a card of a played cycle, wherein a played cycle either three sequential cards of a set or four cards of a set;
stealing any set of cards that have been played by playing a card completing the set of a cycle according to the cycle stage number indicator;
determining whether or not the card game is over;
if the card game is determined not to be over, taking the turn, by a another player; and
if the card game is determined to be over, determining the winner of the card game.

12. The method of claim 11, wherein determining a winner of the card game comprises selecting the player who captured the most number of cycles.

13. The method of claim 12, wherein determining the winner further comprises assigning a point for each cycle played.

14. The method of claim 13, wherein determining the winner further comprises executing a tiebreaker rule when it is determined that two or more players have captured the most number of cycles at the end of the game.

15. The method of claim 14, wherein the tiebreaker rule comprises assigning a bonus point for each complete cycle played.

16. The method of claim 11, wherein the set of rules associated with the card game comprises a first version of gameplay and a second version of gameplay.
